(19) United States
(12) Patent Application Publication
(10) Pub. No.: US 2026/0136237 A1
(43) Pub. Date: May 14, 2026

(54) LOW LATENCY LOW LOSS SCALABLE THROUGHPUT (L4S) DESIGN IN 802.11BN

(71) Applicants: SONY GROUP CORPORATION, Tokyo (JP); SONY CORPORATION OF AMERICA, New York, NY (US)

(72) Inventor: Qing Xia, San Jose, CA (US)

(73) Assignees: SONY GROUP CORPORATION, Tokyo (JP); SONY CORPORATION OF AMERICA, New York, NY (US)

(21) Appl. No.: 19/361,900

(22) Filed: Oct. 17, 2025

Related U.S. Application Data
(60) Provisional application No. 63/718,139, filed on Nov. 8, 2024.

(51) Int. Cl. H04W 28/02; H04L 47/11; H04L 47/2441

(52) U.S. Cl. CPC H04W 28/0273; H04L 47/11; H04L 47/2441; H04W 28/0284

(57) ABSTRACT

A wireless IEEE 802.11 queuing architecture supporting Low Latency Low Loss Scalable throughput (L4S) and Dual Queue Active Queue Management (AQM) in which queues for both L4S streams and classic streams are contained in the medium access control (MAC) layer, and one or more of these queues are configured with more than one internal queue, to which different L4S packets and other packet types are retained in different internal queues within the MAC transmit queues. The MAC queues are configured for MAC layer buffering of L4S packets and classical packets in separate queues and/or queues having internal queues for buffering different packet types, classifications, latency sensitivity, QoS considerations, and so forth. The architecture also allows for multiple packet queues in the upper layers above the MAC layer.

### CROSS-REFERENCE TO RELATED APPLICATIONS

This application claims priority to, and the benefit of, U.S. provisional patent application Ser. No. 63/718,139 filed on Nov. 8, 2024, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to Low Latency Low Loss Scalable Throughput (L4S) stations under IEEE 802.11, and more particularly to a new L4S architecture which can operate at layer 2 (MAC), instead of higher layer 3 or layer 4 levels.

### 2. Background Discussion

Managing queuing delays is especially important for lot latency traffic. The use of Low Latency Low Loss Scalable throughput (L4S) has provided Dual Queue Active Queue Management (AQM) toward reducing queuing delays and providing Explicit Congestion Notification (ECN).

However, the present L4S mechanisms do not optimally mitigate these queuing delays, and suffers from certain inefficiencies.

Accordingly, a need exists for a more robust L4S protocol. The present disclosure fulfills that need and provides additional benefits over existing systems.

### BRIEF SUMMARY

An apparatus and method for enhancing Low Latency Low Loss Scalable throughput (L4S) in IEEE 802.11 wireless networks. Rather than operating in L3 and L4 of the OSI model, the L4S operations are carried out in relation to a Data Link layer (L2) containing the Medium Access Control (MAC) layer and Logical Link Control (LLC) connected to the Physical (PHY) layer (L1).

A wireless protocol having a queuing architecture supporting low latency low loss scalable throughput (L4S) and dual queue active queue management (AQM) in which queues for both L4S streams and classic streams are contained in the medium access control (MAC) layer, and one or more of these queues are configured with more than one internal queue, to which different L4S packets and other packet types are retained in different internal queues within the MAC transmit queues. The MAC queues are configured for MAC layer buffering of L4S packets and classical packets in separate queues and/or queues having internal queues for buffering different packet types, classifications, latency sensitivity, QoS considerations, and so forth.

Explicit congestion notification (ECN) is performed to signal congestion without dropping packets, allowing devices to adjust their transmission rates proactively. ECN comprises detecting congestion at the MAC or PHY layer which is communicated by the MAC layer sending cross-link primitives to upper layers to communicate congestion information, data rate indications, marking packets to indicate contention has been experienced, requests for L4S packet enqueuing, toward supporting L4S features in the MAC layer, which reduce latency of L4S packet transmissions.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a data diagram of L4S signaling messages found in the ECN field in IP header.

FIG. 2 is a flow diagram of using L4S signaling to enable early notification of network congestion to receiver and then to the sender to allow the sender adjusting its sending rate, without dropping packets.

FIG. 3 is a block diagram of L4S Dual Queue Active Queue Management (AQM).

FIG. 4 is a block diagram of communication station hardware, according to at least one embodiment of the present disclosure.

FIG. 5 is a block diagram of Multi-Link Device (MLD) hardware according to at least one embodiment of the present disclosure.

FIG. 6A and FIG. 6B is a queuing architecture for having the L4S Queue in the Medium Access Control (MAC) layer, according to at least one embodiment of the present disclosure.

FIG. 7 is a queuing architecture for adaptive L4S Queue in the MAC layer to compile with legacy 802.11 devices, according to at least one embodiment of the present disclosure.

FIG. 8A and FIG. 8B is a queuing architecture of an L4S Queue above the MAC layer in which the transmit queues in the MAC layer are the same as the current MAC queues, according to at least one embodiment of the present disclosure.

FIG. 9A through FIG. 9C is a queuing architecture for CE marking and CE notification within L4S Queue in the MAC layer, according to at least one embodiment of the present disclosure.

FIG. 10A through FIG. 10C is a queuing architecture for CE marking and CE notification with L4S Queue above MAC layer, according to at least one embodiment of the present disclosure.

FIG. 11A and FIG. 11B is a queuing architecture for inter-layer services primitives between L2 and L3 to signal CE mark with L4S Queue in L2, according to at least one embodiment of the present disclosure.

FIG. 12 is a communication flow diagram of congestion control when applying inter-layer services primitives between L2 and L3 to signal CE mark with L4S Queue in L2, according to at least one embodiment of the present disclosure.

FIG. 13A and FIG. 13B is a queuing architecture for inter-layer services primitives between L2 and L3 to transmit MSDU for CE mark with L4S Queue in L2, according to at least one embodiment of the present disclosure.

FIG. 14 is a communication flow diagram of congestion control when applying inter-layer services primitives between L2 and L3 to transmit MSDU for CE mark with L4S Queue in L2, according to at least one embodiment of the present disclosure.

FIG. 15A and FIG. 15B is a queuing architecture for equivalent ECN Marking in L2 with L4S Queue in L2, according to at least one embodiment of the present disclosure.

FIG. 16 is a communication flow diagram of congestion control when applying equivalent ECN Marking in L2 with L4S Queue in L2, according to at least one embodiment of the present disclosure.

FIG. 17A and FIG. 17B is a queuing architecture for inter-layer flow control services primitives between L2 and L3 with L4S Queue in L2, according to at least one embodiment of the present disclosure.

FIG. 18 is a communication flow diagram of congestion control when applying inter-layer flow control service primitives between L2 and L3 with L4S Queue in L2, according to at least one embodiment of the present disclosure.

FIG. 19 is a queuing architecture showing a new PHY SAP or MLME-PLME SAP inter-layer service primitive providing interactions between the PHY layer and the MAC layer, according to at least one embodiment of the present disclosure.

FIG. 20A and FIG. 20B is a queuing architecture showing a new MAC SAP or MLME SAP inter-layer service primitive that provides interactions between the MAC layer and the upper layer, according to at least one embodiment of the present disclosure.

FIG. 21A and FIG. 21B is a queuing architecture for inter-layer services primitives between L2 and L3 to transmit MSDU for CE mark with L4S Queue above L2, according to at least one embodiment of the present disclosure.

FIG. 22A and FIG. 22B is a queuing architecture of Equivalent ECN Marking in L2 with L4S Queue above L2, according to at least one embodiment of the present disclosure.

FIG. 23A and FIG. 23B is a queuing architecture inter-layer flow control services primitives between L2 and L3 with L4S Queue above L2, according to at least one embodiment of the present disclosure.

FIG. 24 is a data field diagram of an SCS Descriptor element format, according to at least one embodiment of the present disclosure.

FIG. 25 is a data field diagram of QoS Characteristics element format, according to at least one embodiment of the present disclosure.

FIG. 26 is a data field diagram of a Control Info field format of QoS Characteristics element, according to at least one embodiment of the present disclosure.

FIG. 27 is a data field diagram of L4S Characteristics element format, according to at least one embodiment of the present disclosure.

FIG. 28 is a data field diagram of Control Info field format of L4S Characteristics element, according to at least one embodiment of the present disclosure.

### DETAILED DESCRIPTION

### 1. Introduction

The latency in the End-to-End (E2E) path from an application sender to a receiver can be considered in regard to four main factors including: (a) the latency caused by link technologies, such as media access delay and physical layer delays, (b) buffering delays resulting from interactions between the applications, (c) routing path selections, such as the geographical distance between the sender and the receiver and (d) the delay from the endpoints. Among these sources, buffering delays have been identified as a significant and solvable source of E2E latency and latency variation (jitter) across wired and wireless networks.

The queuing/buffering delay in the network arises from network and application interaction at each bottleneck (i.e., has the lowest packet departure rate). The buffering delay get exacerbated by the use of larger buffers to enable higher throughput.

Congestion control or otherwise referred to as rate control, is generally used to reducing application sending rate buffer delays are detected. The primary goals of congestion control includes: (a) preventing congestion collapse, (b) allocating resources fairly and (c) optimizing overall network performance. But due to the limited abilities of present protocols, congestion control and create very high buffer occupancy (and hence delay) in whichever device along the network path is the bottleneck.

The Low Latency Low Loss Scalable Throughput (L4S) has been designed in IETF [RFC9330] to solve the latency issue caused by buffering delay to improve the user experience for a variety of delay-sensitive applications that require low delay and high bandwidth. The delay-sensitive applications include for example, cloud-rendered gaming, HD video conferencing, cloud-rendered interactive video, cloud-rendered virtual reality, augmented reality, remote presence with remote control, interactive light field experiences, and other known applications and those yet to be invented.

### 2. L4S Architecture Background

Key features in L4S architecture includes: (a) new congestion-controlled protocol which solves the root cause of queuing delay; (b) making use of the Explicit Congestion Notification (ECN) field in the Internet Protocol (IP) header to notify the client that congestion is being experienced; and (c) use of Dual Queue Active Queue Management (AQM) to support L4S and legacy traffic.

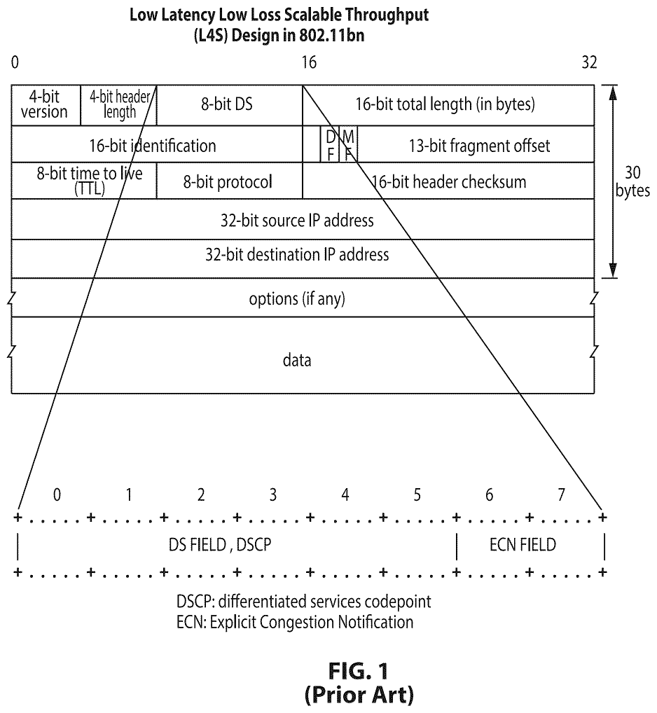

FIG. 1 illustrates L4S signaling messages found in the ECN field in IP header as shown with the ECN codepoint values shown in Table 1. As shown in FIG. 1, the ECN field uses the last two bits in the original Differentiated Services (DS) field of the IP header. The ECN signals the L4S capable transport with ECT(1) (ECN=01) and Congestion experienced with CE (ECN=11).

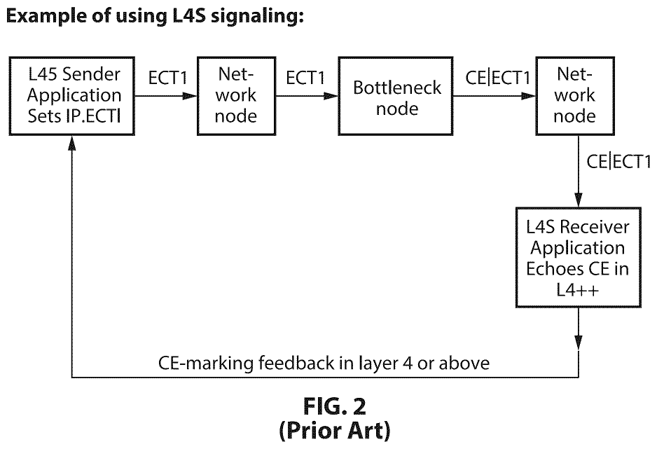

FIG. 2 depicts an example of using L4S signaling to enable early notification of network congestion to a receiver and then to the sender to allow the sender to adjust its sending rate without dropping packets. L4S capable transport is supported at the L4S sender, at the bottleneck node, and at the L4S receiver.

The L4S sender is seen sending a packet indicating in its IP header with ECT1 (ECN=01) to indicate it support L4S-capable transport to a network node. The packet with ECT1 indicated then passes this one network node, which is not a ‘bottleneck node’ of the network, and ECT1 is not changed. However, as the packet arrives at the bottleneck node of the network, in which network congestion is experienced, then the ECN field of the packet is further marked with CE (ECN=11) to indicate that congestion has been experienced. The CE marking is finally received by the L4S receiving network node. The L4S receiver should then send congestion feedback to the sender at Layer 4, within its transport layer. The L4S sender receives the congestion feedback from L4S receiver at Layer 4 and should reduce its data rate to minimize congestion.

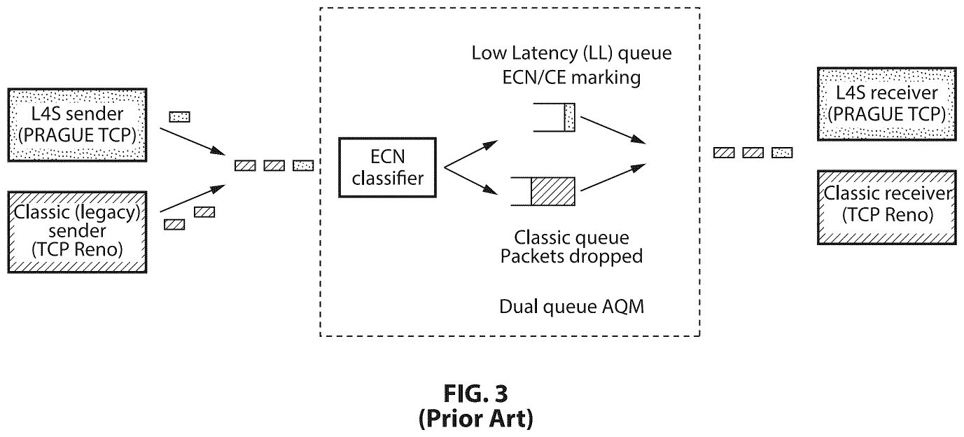

FIG. 3 depicts L4S Dual Queue Active Queue Management (AQM). To coexist with classic congestion-control traffic, Dual-Queue Coupled AQM uses two queues, one for L4S traffic and one for classic traffic. The classic queue is for non-L4S flows, such as video streaming, downloads, and bulk data. When the classic queue reaches a drop threshold level, the AQM for the classic queue should drop packets. A shallow L4S queue is for L4S flows, for example AR/VR, HQ video conferencing, cloud gaming, or similar low latency traffic. An L4S AQM can immediately signal queue growth using ECN, catching queue growth early, eliminating packet discard. The dual queue AQM isolates L4S flows from the queuing of classic flows and sends congestion signals appropriately scaled for each type of traffic.

2.1. A different AQM Model Exists.

The dual queue coupled AQM involves two AQM algorithms (processes) running simultaneously. A classic AQM monitors the queue delay of the classic queue and calculates (determines) a drop probability that will be applied to packets in that queue, while the native AQM monitors the queue delay of the L4S queue and calculates a marking probability that will be applied to the packets in the L4S queue.

The native AQM for L4S in Wi-Fi involves the Wi-Fi device calculating (determining) the amount of data to fill into a single Transmit Opportunity (TXOP) and CE-marking packets that arrive to a queue that contains more than the number of bytes to fill a given number of TXOPs (e.g., n*TXOP), where n is an implementation dependent scaling factor, such as in the range of 1 to 2 that allows some level of compromise between throughput and buffering delay. Once the aggregation limit is reached, the device stops dequeuing any packets from the upper layer queue to the Medium Access Control (MAC) queue until the MAC successfully delivers some Aggregated MAC Protocol Data Units (AMPDUs) over the air. Once the MAC buffer has again reached the aggregation limit, any packets that remains in the upper layer L4S queue are to be CE-marked.

In the dual queue coupled AQMs with weighted scheduling, the classic AQM applies a drop threshold level to classic traffic that is coupled to the certain level, e.g., square, of the CE marking level being applied to Low Latency (LL) traffic. In this case, the packet rates of the two types of flow have been found to be approximately the same. The coupling factor (along with some exogenous factors) determines the relative traffic rates in the two queues. A weighting of approximately 90% for the L4S LL queue is considered to be a workable value, but it is recommended that this parameter be configurable. The allocation among L4S LL queue and the classic queue also depends on the MAC and PHY layer information, such as Modulation Coding Scheme (MCS), Number of Spatial Streams (NSS), channel bandwidth, TXOP limitation, or other communication parameters.

### 3. Problem Statement

The problem to be addressed are primarily lengthy (overly long) delay times and the introduction of jitter due to implementation of large buffers filled by classic congestion control traffic.

Implementing L4S can solve buffering delay, however, in approaching the present disclosure, it has been determined that the present L4S mechanisms do not optimally address the issues. In particular, L4S operates at the Open Systems Interconnection (OSI) layer 3 and/or layer 4, while the L4S technology should best be adaptively designed to cope with solving address buffering delays that occur at layer 2 (MAC layer). Integration of per Flow Queue (FQ) in the 802.11 MAC can be challenging to implement, since MAC queues are commonly implemented in hardware, and FQ requires a very large number of queues. The 802.11 MAC does not have the capability to CE-mark packets, which is processed on L3 or L4.

In order to support L4S, current 802.11 implementations will require the following capabilities. (a) A new queue architecture is necessary, e.g., separate queues for classic traffic and L4S LL traffic independently while maintaining smaller queue sizes for L4S queues. (b) The AQM should ensure that the Buffered Units (BUs) in the L4S queue should filled to a certain degree so that it can efficiently use the link capacity, i.e., efficiently fill per TXOP. (c) The AQM should continuously update the estimated aggregation buffer size as MAC and PHY parameter changes, such as channel conditions, MCS, NSS, channel bandwidth, TXOP limitations, and channel access rules. (d) The dequeue of the Buffer Units (BUs) that have been successfully transmitted, i.e., a BlockAck (BA) has been received in L2 should be processed in a sufficiently timely manner, based on the new L4S queueing architecture. (e) The device must be capable of maintaining separate queues for L4S and the classic traffic flows; while only combining flows in the aggregation buffer shortly before transmission. (f) Supporting L4S also involves providing appropriate congestion signals to inform upper transport layers about the congestion at MAC layer.

### 4. Solution Statement

The present disclosure presents a new L4S architecture which has the following benefits, which are described as following by way of example and not limitation. (1) New queuing architectures are designed separately, depending on whether L4S queues are implemented at the MAC layer, or above MAC layer. (2) New cross-link primitives are defined between MAC, PHY and the upper layers to support L4S feature in 802.11, which are separately designed based on different queuing architectures. (3) New CE marking is described for the 802.11 MAC and a new CE marking is provided which operates above the 802.11 MAC, and configured according to their different queuing architectures. (4) A new Traffic Classification (TCLAS) element is designed to classify the Protocol Data Unit (PDU) or Mac Service Data Unit (MSDU) from an upper layer in L4S traffic. (5) A new Stream Classification Service (SCS) descriptor element is designed to reflect the coexistence of SCS flows and L4S flows.

### 5. Communication Hardware Embodiments

### 5.1. Communication Station (STA and MLD) Hardware

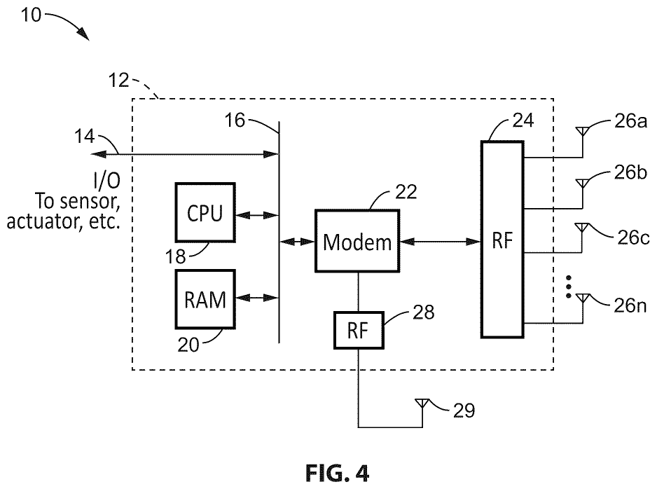

FIG. 4 illustrates an example embodiment 10 of STA hardware configured for executing the protocol of the present disclosure. An external I/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an Access Point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication protocol and context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

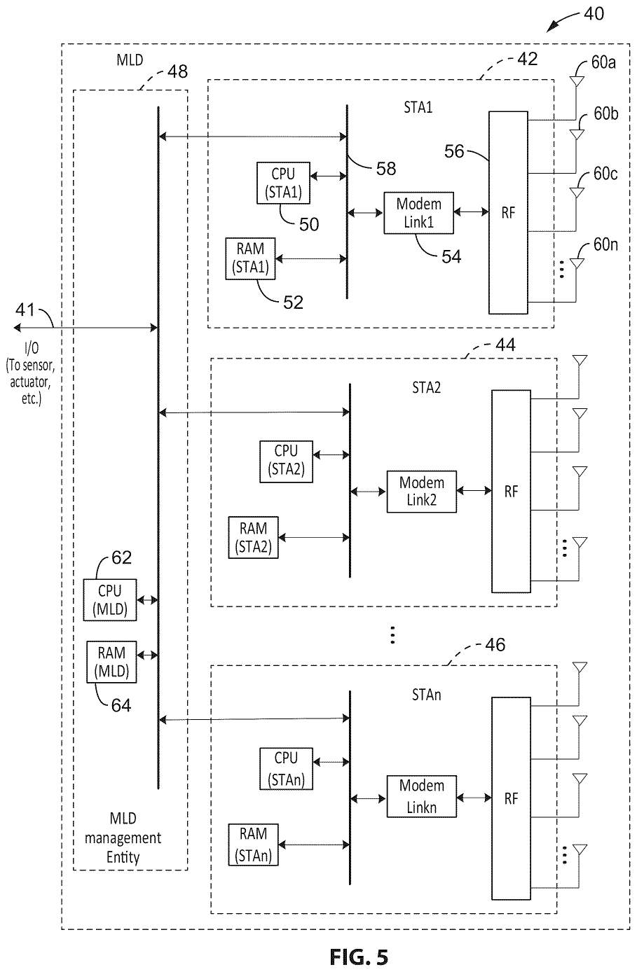

FIG. 5 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4 GHz, 5 GHz and 6 GHZ. Among multiple radios, basic link sets are the link pairs that satisfy simultaneous transmission and reception (STR) mode, e.g., basic link set (2.4 GHz and 5 GHZ), basic link set (2.4 GHz and 6 GHZ).

The conditional link is a link that forms a non-simultaneous transmission and reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA 1 42, STA 2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

### 6. Queuing Architecture

### 6.1. L4S Queue in the MAC Layer

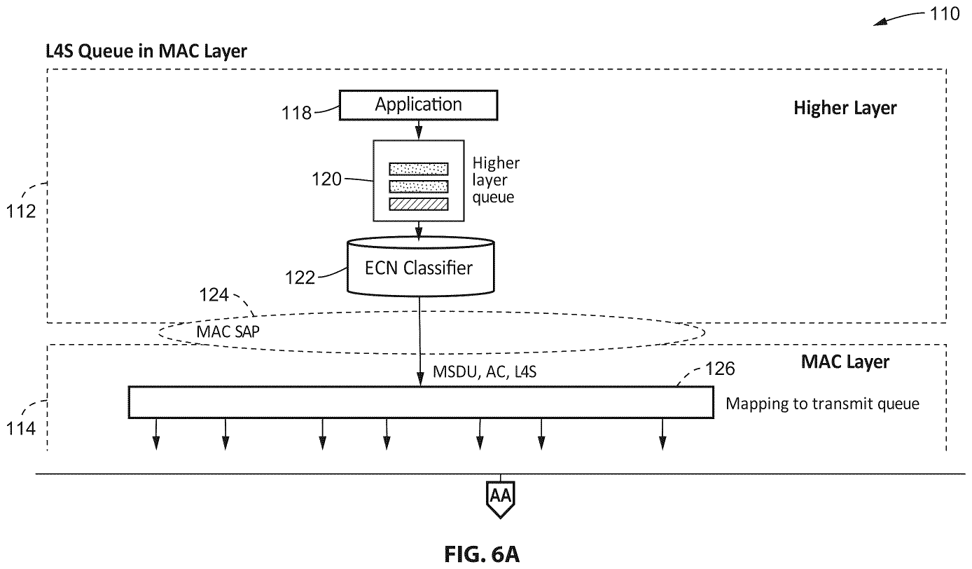

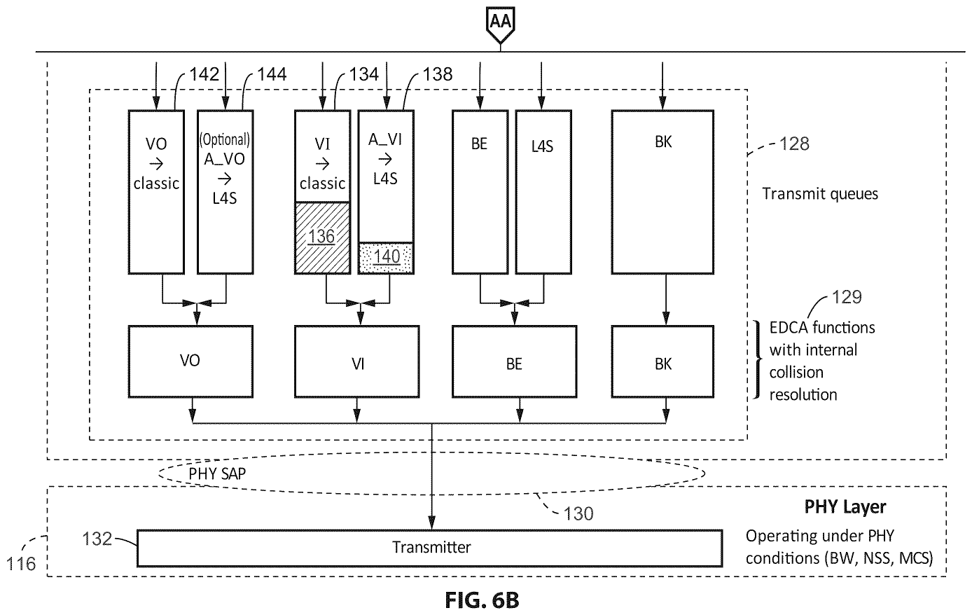

FIG. 6A and FIG. 6B illustrate an example embodiment 110 having the L4S Queue in the Medium Access Control (MAC) layer. The figure depicts a higher layer level 112, that is above the MAC layer 114. This is shown with application layer 118, above a higher level queue 120 over an ECN classifier 122 which goes through a MAC Secure Authentication Protocol (SAP) 124, to the MAC layer 114, shown with mapping 126 to transmit queues 128 (FIG. 6B) that are shown with EDCA functions 129 having internal collision resolution, and dedicated transmit queues shown for VO, VI, BE and BK. Output from the queues is then directed to the transmitter 132 of the physical layer (PHY) 116 through the PHY SAP 130.

In at least one embodiment L4S dual queue AQM is implemented for access category (AC)_VI in 802.11 reusing the queue architecture of VI showing VI queue 134 with an internal queue portion 136 for Classic traffic, thus it is configured for dual queues. Similarly, A_VI queue 138 has an internal queue portion 140 for storing L4S traffic.

In at least one embodiment L4S dual queue AQM is optionally implemented for AC_VO in 802.11 by maintaining the VO queue 142 to maintain all classic AC_VO traffic, and for the A_VO queue 144 in at least one embodiment to serve L4S flow of AC_VO traffic. Another similar embodiment (not shown) is to use this A_VO queue to serve L4S flows of AC_BE traffic.

In at least one embodiment L4S dual queue AQM is implemented for AC_BE in 802.11 by maintaining the only BE queue to continue storing all classic AC_BE traffic. For the L4S queue of the AC_BE, at least one embodiment uses the A_VO queue to serve an L4S flow of AC_BE traffic, under the condition that AC_VO traffic doesn't require a separate L4S queue for itself. Otherwise, in at least one other embodiment, the device requires having a new queue for storing L4S LL traffic of AC_BE.

In at least one embodiment the length of the L4S queues are intentionally limited to having a smaller queue size, thereby reducing buffering delay for the L4S LL traffic, while still being able to maintain at least a sufficient number of MSDUs to be transmitted, in for example, one to two Transmit Opportunities (TXOP(s)).

In at least one embodiment in an ECN Classifier, which is located above the MAC layer, the traffic is classified based on the QoS/SCS, AC and L4S information. Then the classified traffic is further mapped to different transmit queues.

Considering the possibility of the device supporting L4S dual queues in the 802.11 MAC layer, communication is established with another legacy device that doesn't support L4S in 802.11 based on certain QoS requirements. The User Priority (UP)-to-Access Class (AC) mapping as understood by the legacy device are no longer valid in the device supporting a new L4S dual queue architecture. To avoid this conflict, the following options can be applied for different embodiments.

(A) In at least one embodiment the legacy device should not map and/or request a peer to map the specific User Priority (UP) to the L4S queues. It will be noted that User Priority is a 3 bit field having values from 0 to 7. For example, consider UP 4 was originally mapped to AC_VI to use A_VI transmit queue, and UP 7 was originally mapped to AC_VO to use A_VO transmit queue. However, in the new L4S dual queue architecture as shown in FIG. 6A and FIG. 6B, A_VI and A_VO transmit queues are used as L4S queues, thus UP 4 and UP 7 should not be applied by the legacy STA. This can be achieved through SCS negotiation, as described in Section 9.1.

(B) In at least one other embodiment, instead of preventing original UP-to-AC mapping and UP to transmit queue mapping for legacy devices, the device supporting L4S dual queue should simultaneously support legacy UP-to-AC mapping and UP to transmit queue mapping to be backward compatible with legacy 802.11 devices.

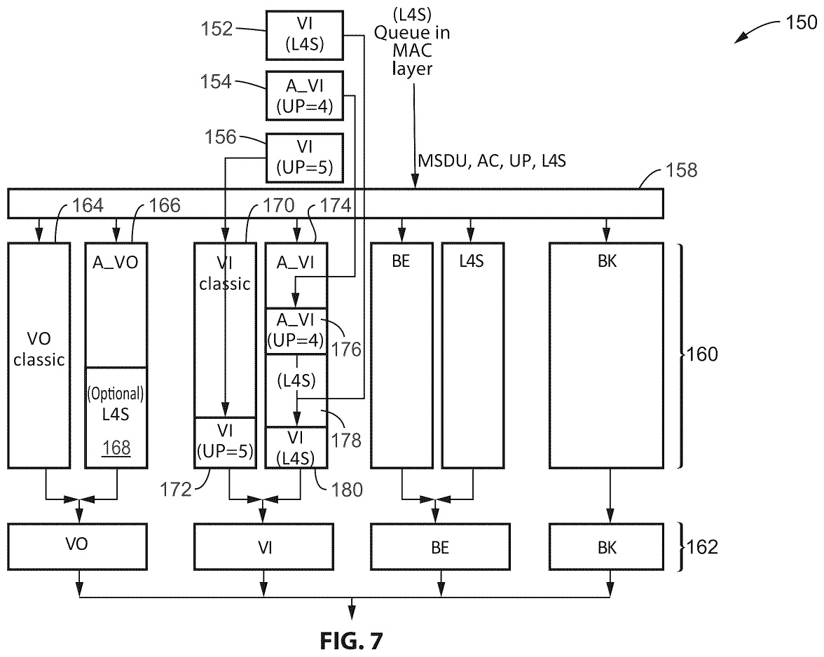

FIG. 7 illustrates an example embodiment 150 of adaptive L4S Queue in the MAC layer to compile with legacy 802.11 devices. The device supporting L4S dual queue architecture remains a partial of A_VO and A_VI transmit queues that are consecutively connected after the L4S queues of AC_VO and AC_VI. The figure depicts the MAC layer with its mapping 158, queues 160, and EDCA 162 with its dedicated transmit queues exemplified for VO, VI, BE and BK.

Queues are shown as: Classic queue 164, A_VO queue 166 with optional L4S internal queue portion 168, Classic 170 queue shown with VI internal queue portions 172, A_VI queue 174 with internal queue portions 176, 178, 180.

A packet receipt example is described with the AP supporting L4S having DL traffic to multiple-STAs, among which exist legacy 802.11 STA(s) not supporting L4S. The DL traffic arrives at the MAC layer in series, in the order of VI (UP=5) 156, A_VI (UP=4) 154, and VI (L4S) 152. The AP maps these to different transmit queues, for example the VI packet (UP=5) 156 is mapped to the classic queue 170 of VI in internal queue 172, the A_VI packet (UP=4) 154 is mapped to A_VI+L4S queue, but it is stored first in the A_VI internal queue 176 of the transmit queue, the packet VI (L4S) 152, although it arrives the latest, is injected to the L4S internal queue 178 of the A_VI+L4S queue, and is located closer to the exit of this queue. The A_VI (UP=4) 154 packet can be pushed forward 180 to aggregate with VI (L4S) packet 178 when there is no further arrival of VI (L4S) packets and the buffered VI (L4S) packets haven't met the congestion level and there is still space left in the aggregated PPDUs to fill in the upcoming TXOP for this DL transmission.

### 6.2. L4S Queue Above MAC Layer

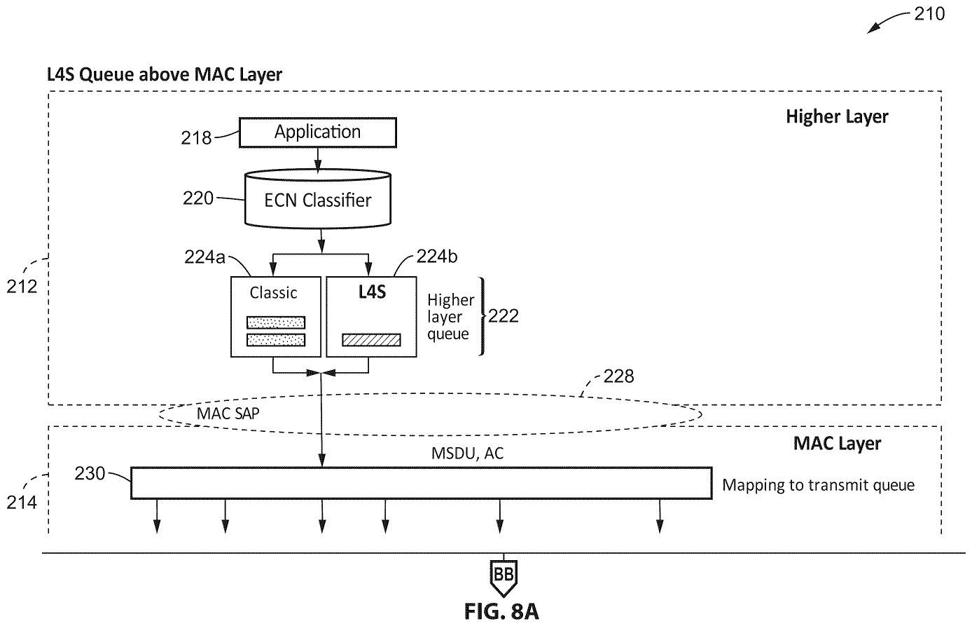

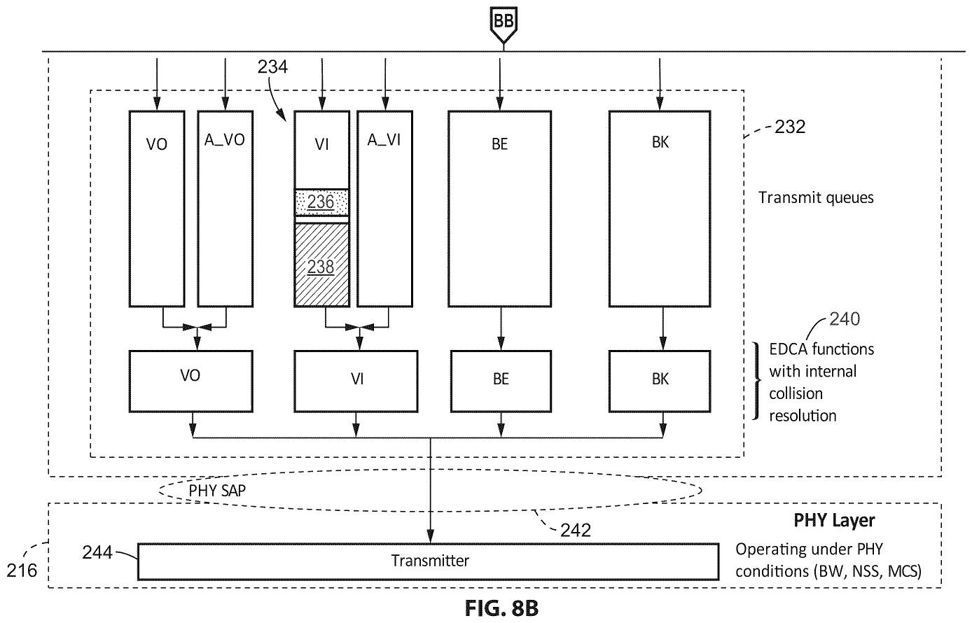

FIG. 8A and FIG. 8B illustrate an example embodiment 210 of L4S Queuing above the MAC layer. The figure depicts a higher layer level 212, that is above the MAC layer 214, which is over the PHY layer 216.

This higher level 212 is shown with application layer 218, above an ECN classifier 220, connecting to a higher level queue 222, with classic 224a and L4S 224b queues which connect through a MAC Secure Authentication Protocol (SAP) 228, to the MAC layer 214 with its mapping 230 to transmit queues 232 that are shown with EDCA functions 240 having internal collision resolution, and shown with its dedicated transmit queues exemplified for VO, VI, BE and BK. Output from the queues is then directed to the transmitter 244 of the physical layer (PHY) 216 through the PHY SAP 242.

The transmit queues are shown including VI 234 with dual internal queues 236, 238.

In at least one embodiment, the L4S dual queue architecture is implemented above the MAC layer, where the transmit queues at the MAC layer are the same as the current MAC queues. The dual queue AQM is implemented above the MAC and is used for managing one classic queue and one L4S queue. The packets from the classic queue and L4S queue can be mapped to AC_VI queue in MAC layer as shown in the figure or can be mapped to any of the other AC queues in the MAC layer (not shown). According to the congestion status, the packets in the classic queue and the LL packets in the L4S queue could be dropped and be processed with the CE mark, respectively.

In at least one embodiment, the ECN classification is configured to classify flows for inserting packets into Classic and L4S queues.

In at least one embodiment, the AC queue mapping can be performed when the ECN classifier classifies the traffic flow into classic and L4S queues. In another embodiment, the AC queue mapping is performed when the packets from classic and L4S queues arrives at the MAC layer and the MAC layer unit maps them into different transmit queues according to different ACs.

### 7. CE Marking and CE Notification

7.1. CE Marking and CE Notification when L4S Queue is in L2

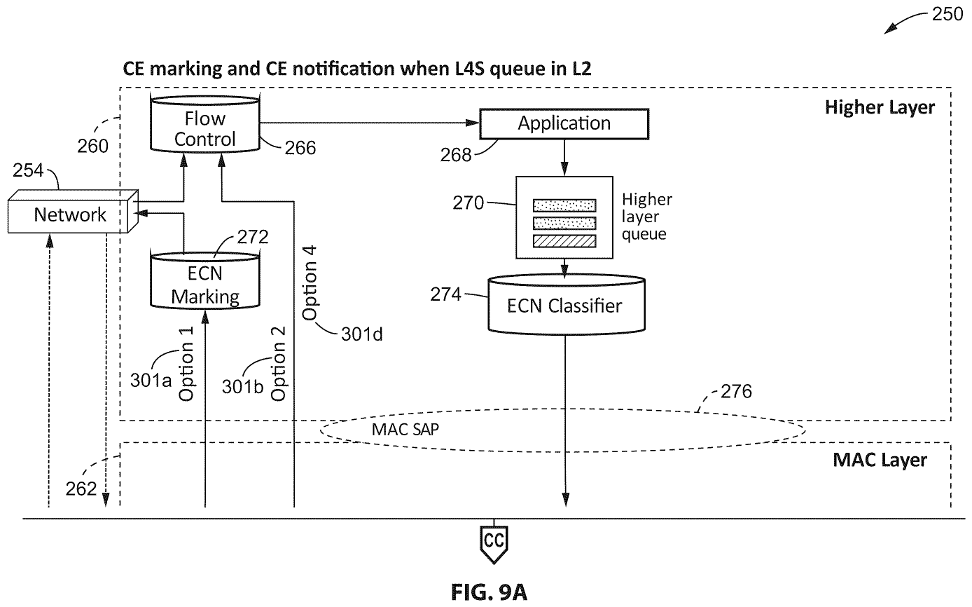

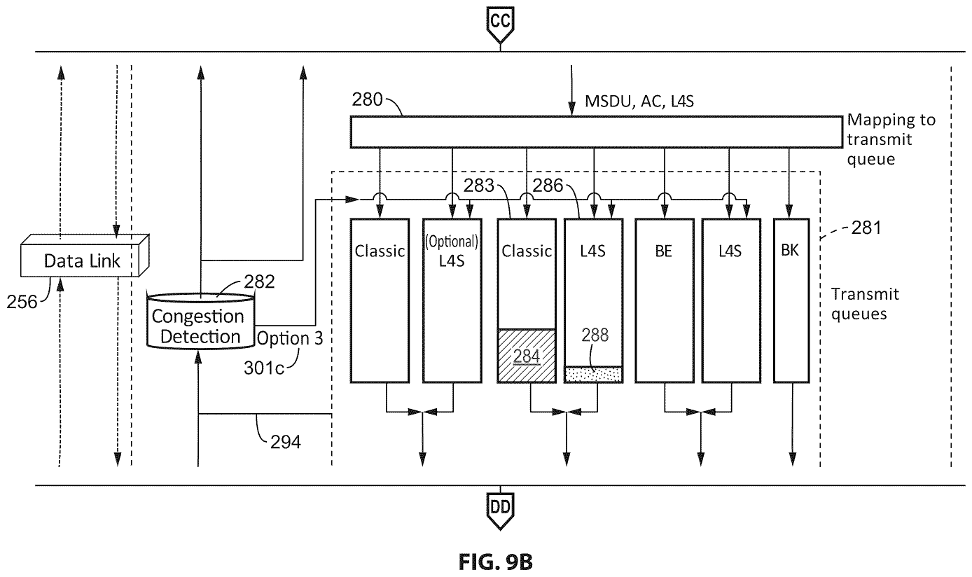

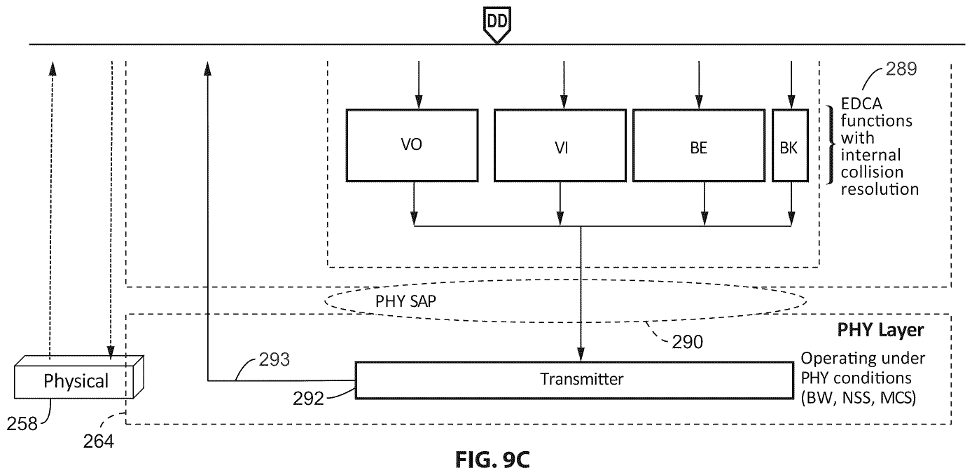

FIG. 9A through FIG. 9C illustrate an example embodiment 250 of CE marking and CE notification within L4S Queue in the MAC layer. Summarizing the flow of the figure, a higher layer 260 (higher than the MAC layer) is shown, over a MAC layer 262 in FIG. 9A and FIG. 9B, which is connected to the PHY layer 264 in FIG. 9C.

In this higher layer is shown a network 254 connected to a Data Link 256 in the MAC layer of FIG. 9B, that is connected to the Physical layer 258 of FIG. 9C. In FIG. 9A the Network 254 is connected to Flow Control 266 which is connected to the Application 268, beneath which is depicted a higher layer queue 270 to an ECN Classifier 274 which is connected through the MAC SAP 276 to MAC mapping 280 in FIG. 9B to the transmit queues 281, shown with various queues, including Classic, (optional) L4S, Classic 283 with a dual queue element 284, and an L4S queue 286 with dual queue element 288, then BE queue, L4S queue, and BK queue. Output from these queues are seen reaching the EDCA functions 289, with its dedicated transmit queues exemplified for VO, VI, BE and BK, and whose output is through the PHY SAP 290 to transmitter 292 and output 293 Congestion Detection 282, shown with an option 3 301c to the transmit queues 281. Congestion Detection 282 can also interact with the L4S queues.

Other optional outputs are shown from Congestion Detection 282, such as Option 1 301a to ECN Marking 272, and Options 2 and 4 to Flow Control 266. These elements and options are discussed with increased particularity below.

In Option 1 301a congestion control signals are for ECN marking of a subsequent MSDU. In Option 2 301b moving MSDU for performing ECN marking congestion control signals ECN marking for subsequent MSDU. In Option 3 301c signals that ECN marking in the MAC layer takes place. Congestion control signals ECN marking for subsequent MSDU. In Option 4 301d the signal from congestion detection bypasses ECN marking and goes to flow control 266. The figure also shows how congestion control 282 is connected 294 to the queues.

The ECN marking is processed in the IP header at L3, i.e., network layer, as was shown in FIG. 1. In this context, MAC layer does not examine the IP header.

In at least one embodiment, an ECN classifier 274 signals the MAC layer about enqueuing of the L4S packet and the MAC layer classifies and stores the L4S packet in the proper queue according to that classification.

In at least one embodiment, the MAC layer performs congestion detection 282 in any of the L4S queues, as shown in the figure, and then signals L3 to process ECN marking for the subsequent packets of a specific L4S flow in the higher layer queue(s). In at least one embodiment an indication signal should be sent to upper layers for CE marking in the ECN Marking 272, such as by request L3 to set ECN=11 (CE) in the IP header of the L4S traffic before enqueuing it into the MAC queue. As described in Section 8.1.1.

In at least one other embodiment, the MAC layer detects the congestion 282 in any of the L4S queues, as shown in the figure, and passes the buffered MSDU(s) to the upper layer for CE marking. Once the upper layer finishes CE marking of that MSDU(s), it inserts that MSDU(s) back to the MAC queue.

A request and a response primitive between the MAC and the upper layer should be configured to achieve this, as described in Section 8.1.2.

In at least one other embodiment, the MAC layer detects the congestion in any of the L4S queues, and marks in the frame format as understood in the MAC layer to indicate CE from MAC header marking. In at least one embodiment, an indication signal is utilized to achieve this, as described in Section 8.1.3.

In another embodiment, the MAC layer detects the congestion also based on PHY information, such as BW, NSS, and MCS. In at least one embodiment, an indication signal is configured to achieve this goal as described in Section 8.1.4.

In at least one embodiment, the packet with the CE mark in the IP header or in the MAC header is sent out and received by the receiver as was shown in FIG. 2. The L4S receiver sends congestion feedback to the sender. The sender, receiving the congestion feedback from the L4S receiver, reduces its data rate through flow control toward reducing congestion.

In another embodiment, the MAC layer can detect congestion in any of the L4S queues, as shown in FIG. 9A through FIG. 9C, and then signal the flow control unit in the above layer(s) to slow down the enqueuing (manage the enqueuing) of the specific flow. An indication signal is configured to achieve this, as described in Section 8.1.5.

7.2. CE Marking and Notification when L4S Queue in L3 or Above

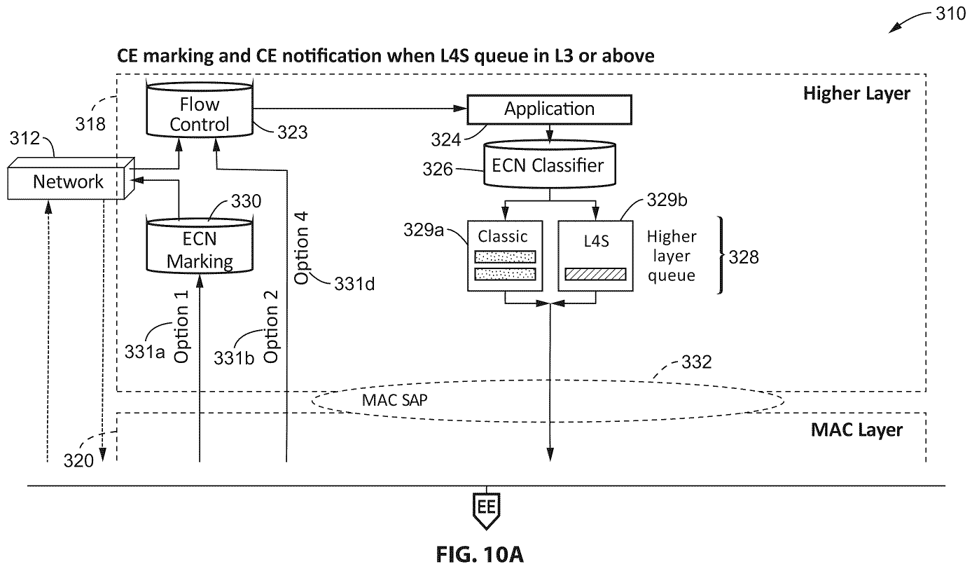

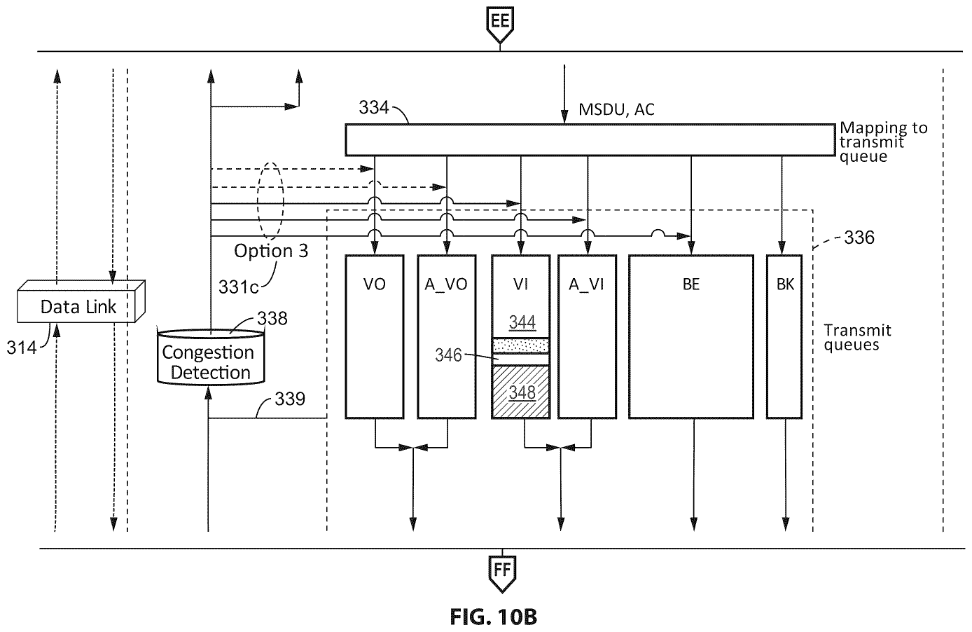

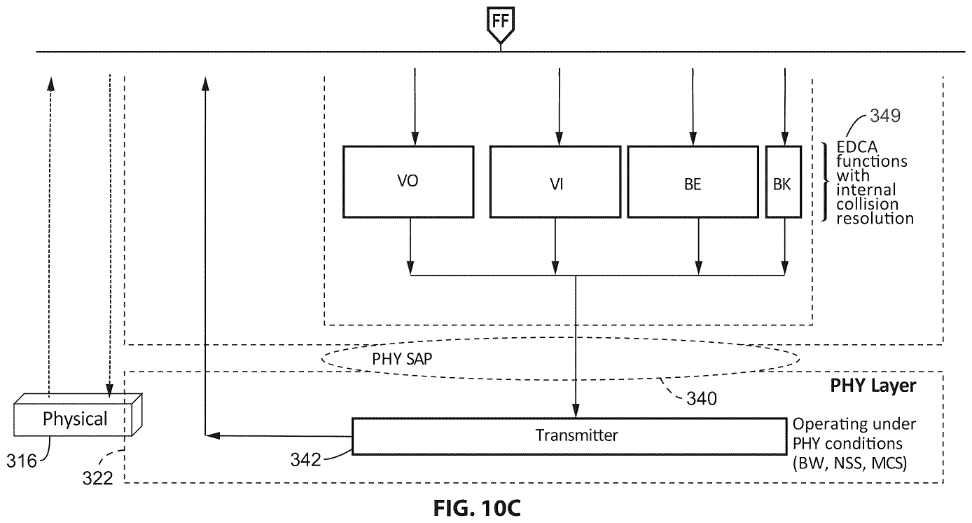

FIG. 10A through FIG. 10C illustrate an example embodiment 310 of CE marking and CE notification with L4S Queuing above the MAC layer.

Summarizing the flow of the figure, a higher layer 318 (higher than the MAC layer) is shown, over a MAC layer 320 in FIG. 10A and FIG. 10B, which is connected to the PHY layer 322 in FIG. 10C.

In this higher layer is shown a network 312 connected to a Data Link 314 in the MAC layer (FIG. 10B), that is connected to the Physical layer 316 in FIG. 10C. In FIG. 10A the Network 312 is connected to Flow Control 323 which is connected to the Application 324, beneath which is depicted an ECN Classifier 326 to multiple higher layer queues 328, exemplified with Classic queue 329a and L4S queue 329b, the output of which is through the MAC SAP 332 to MAC mapping 334 in FIG. 10B to the transmit queues 336, shown with various queues, including VO, A_VO, VI, A_VI, BE and BK, by way of example and not limitation. In this example the VI queue 344 has internal queues 346, 348. Output from these queues are seen reaching the EDCA functions 349 with dedicated transmit queues exemplified for VO, VI, BE and BK, whose output is through the PHY SAP 340 to transmitter 342.

In the figure are shown various options in regard to Congestion Detection 338 of FIG. 10B in the MAC layer, and ECN Marking 330 in FIG. 10A, in relation to Flow Control 323. In the figure, Congestion Detection 338 can also interact with the L4S queues, and is shown for accessing VI, A_VI and BE, and optionally (dashed lines) VO, and A_VO. These elements and options are discussed with increased particularity below.

In Option 1 331a congestion control signals ECN marking for subsequent MSDU. In Option 2 331b transiting (moving) MSDU for ECN performing marking congestion control signals ECN marking for subsequent MSDU. In Option 3 331c ECN marking is signaled in the MAC layer congestion control signals ECN marking for subsequent MSDU. In Option 4 331d the signal from congestion detection bypasses ECN marking and goes to flow control 323. The figure also shows how congestion control 338 is connected 339 to the queues.

In at least one embodiment, the MAC layer detects the congestion in any of MAC transmit queues that has the L4S LL packet(s) inserted in it, as shown in the figure, and then signals L3 to process ECN marking for the subsequent packets of a specific L4S flow in the corresponding L4S queue(s).

An indication signal should be sent to upper layers for CE marking, such as using a request L3 to set ECN=11 (CE) in the IP header of the L4S traffic before enqueuing it into the MAC queue, as described in Section 8.2.1.

In at least one embodiment, the L4S dual AQM in L3 can also drop packet(s) in the classic queue when receiving an indication of congestion being experienced as signaled from the MAC layer.

In another embodiment, the MAC layer detects congestion in any of the transmit queues that have the L4S LL packet(s) inserted in them, as shown in FIG. 10A through FIG. 10C, and passes the buffered MSDU(s) to the upper layer for CE marking. Once the upper layer finishes marking CE of that MSDU(s), it should then be inserted in that MSDU(s) back to the MAC queue.

A request and a response primitive between MAC and upper layer is configured to achieve this, as described in Section 8.2.2.

In at least one embodiment, the L4S dual AQM in L3 can also drop packet(s) in the classic queue when receiving the MSDU(s) from MAC layer as a request for CE marking.

In another embodiment, the MAC layer detects congestion in any of the MAC transmit queues that have the L4S LL packet(s) inserted in them, and marks the frame format understood in the MAC layer to indicate CE from MAC header marking.

An indication signal is configured to achieve this, as described in Section 8.2.3.

In at least one embodiment, the packet with the CE mark in the IP header or in the MAC header will be sent out and received by the receiver as shown in FIG. 2. The L4S receiver then sends congestion feedback to the sender. The sender receiving the congestion feedback from the L4S receiver should/must reduce its data rate through flow control to reduce congestion.

In another embodiment, the MAC layer detects congestion in any of the MAC transmit queues that has the L4S LL packet(s) inserted in it, as shown in FIG. 10A through FIG. 10C, and then signals flow this to the control unit in the above layer(s) to slow down the enqueuing of the specific flow. An indication signal is configured to achieve this, as designed in 8.2.4.

In another embodiment, the MAC layer also detects congestion based on PHY information, such as BW, NSS, MCS. An indication signal is configured to achieve this goal as described in Section 8.1.5.

### 8. Primitive Design

8.1. Primitive when L4S Queue is in L2
8.1.1. Signaling ECN Marking from L2 to L3

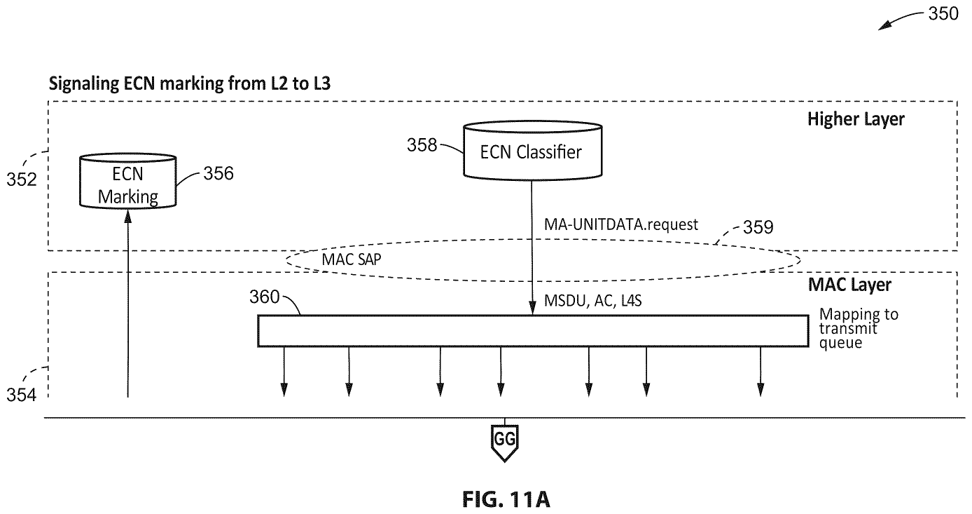

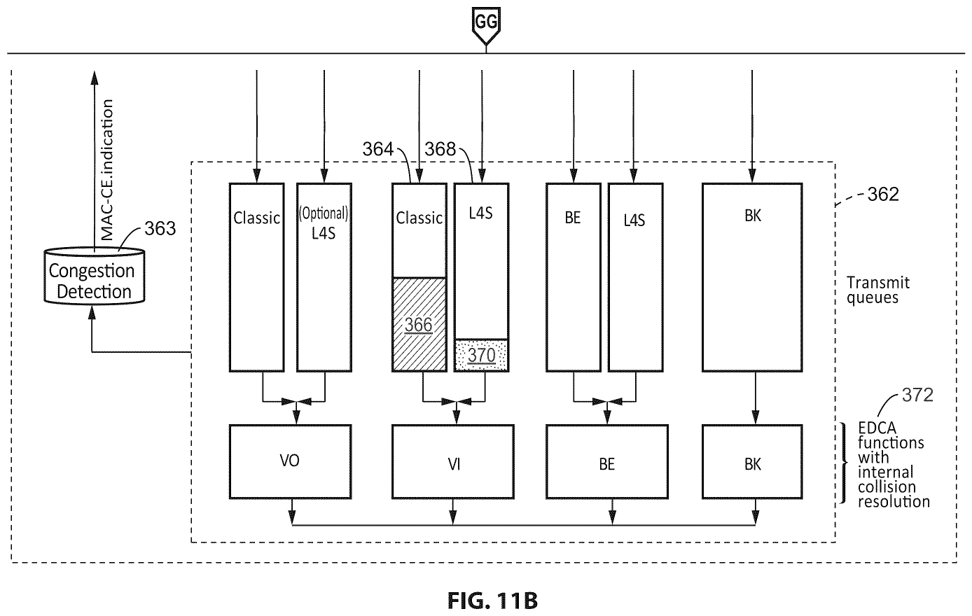

FIG. 11A and FIG. 11B illustrate an example embodiment 350 of Inter-layer services primitives between L2 and L3 to signal CE mark with L4S Queue in L2.

In FIG. 11A is depicted a higher layer level 352, that is above the MAC layer 354. This higher layer is shown with ECN marking 356 and ECN classifier 358 which connects through a MAC Secure Authentication Protocol (SAP) 359, to the MAC layer 354, shown with mapping 360 to transmit queues 362 in FIG. 11B that are shown with EDCA functions 372 having internal collision resolution and dedicated transmit queues exemplified for VO, VI, BE and BK. Congestion detection 363 is also shown with MAC-CE.indication. In this example on Classic queue 364 is shown with internal queue 366, and an L4S queue 368 with internal queue 370; other queues depicted by example are Classic, L4S (optional), BE, L4S, and BK.

In at least one embodiment, a new MAC SAP or MLME SAP inter-layer service primitive is described which interacts between the MAC layer and the upper layer. This primitive, exemplified as MAC-CE.indication, as shown in the figure, indicates the transfer of information about the congestion being experienced from the MAC to the local L3 entity called ECN Marking 356 to perform the CE marking. The receipt of this primitive by the L3 entity causes the ECN Marking entity to mark CE within the IP header of the subsequent L4S packets before moving them to the MAC layer.

In at least one other embodiment, L3 management entity can estimate a flow rate and insert that information into the MAC queue(s).

The MAC-CE.indication primitive provides the following parameters that includes but are not limited to:

MAC-CE.indication(

source address,
destination address,
priority,

SCSID,

L4S congestion indication,
drop rate of classic queue (optional),
data rate,
medium time,

)

The Source Address (SA) parameter specifies an individual MAC sublayer address of the sublayer entity from which the MSDU is experiencing congestion at the MAC layer. The Destination Address (DA) parameter specifies either an individual or a group MAC sublayer entity address.

The Priority parameter specifies the priority of the MSDU that is experiencing congestion at the MAC layer. The SCSID parameter indicates the SCSID of the MSDU that is experiencing congestion at the MAC layer. The L4S Congestion Indication parameter specifies a vector parameter as needed to manage the L4S congestion at the MAC layer, such as the L4S congestion level. The Drop Rate parameter of the classic queue specifies the drop rate of the classic queue in L4S queue architecture at the MAC layer. The Data Rate parameter specifies the estimated PHY data rate as introduced in Section 8.1.4. The Medium Time parameter specifies the expected medium time for transmitting subsequent MPDU(s).

In the current specification, MA-UNITDATA.request primitive requests a transfer of an MSDU from a local LLC sublayer entity to a single peer LLC sublayer entity or bridge port, or multiple peer LLC sublayer entities or bridge port in the case of group addresses.

In at least one embodiment, the upper layer unit uses an MA-UNITDATA.request primitive to signal the MAC layer to enqueue the L4S packet. Thus, a new parameter is described for this primitive for identifying the L4S MSDU.

In at least one embodiment, the parameters of the primitive are as follows (with new parameter marked with underscore):

MA-UNITDATA.request (

source address,
destination address,
routing information,
data,
priority,
drop eligible,
...
SCSID,
L4S identification,
L4S congestion indication

)

The Source Address (SA) parameter specifies an individual MAC sublayer address of the sublayer entity from which the MSDU is being transferred. The Destination Address (DA) parameter specifies either an individual or a group MAC sublayer entity address.

The Routing Information parameter specifies the route for the data transfer. The Data parameter specifies the MSDU to be transmitted by the MAC sublayer entity. The Priority parameter specifies the requested priority of the data transfer. The Drop Eligible parameter indicates whether this MSDU can be discarded in preference to other MSDUs when there are insufficient resources in a STA. The SCSID parameter indicates the SCSID of the MSDU that is being transferred. The L4S Identification parameter specifies that the MSDU is a L4S LL MSDU, which is classified and enqueued in the L4S queue at the MAC layer. The L4S Congestion Indication parameter specifies a vector parameter as needed to manage the L4S congestion, such as L4S congestion level and capability of signaling the upper layer about the congestion. The Congestion Level parameter specifies the maximum number of bytes or number of MSDUs or A-MSDUs that can be inserted in the MAC queue before it begins to experience congestion.

The signaling sent to the upper layer about the congestion, includes but is not limited to, signaling information about the current congestion level and requesting a CE mark.

In at least one other embodiment, the L4S identification and L4S congestion indication can also be included in the MA-UNITDATA.indication primitive and the MA-UNITDATA-STATUS.indication primitive.

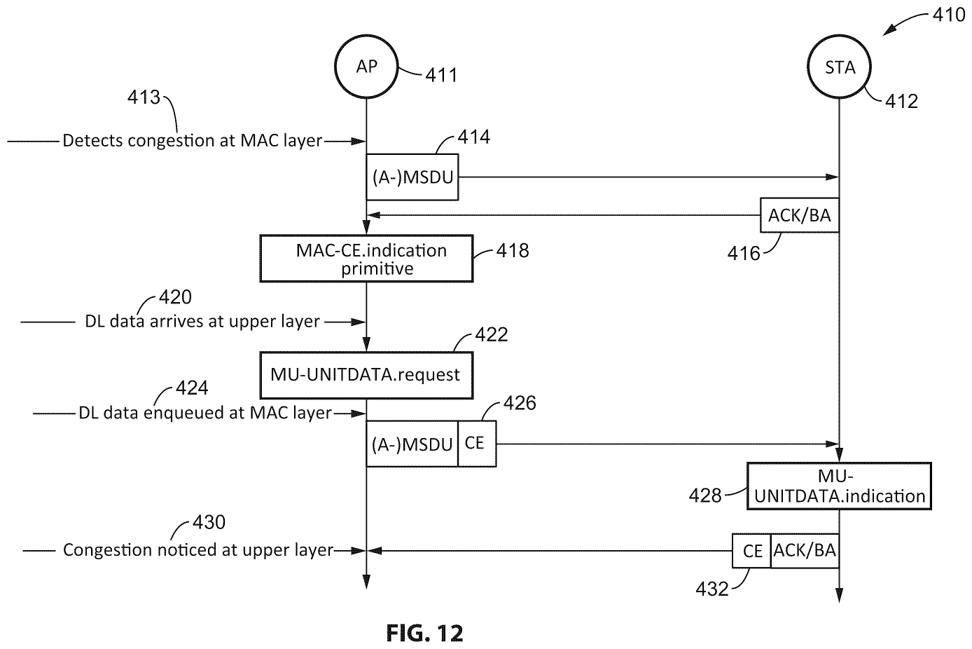

In at least one embodiment, an illustration of congestion control when applying inter-layer services primitives between L2 and L3 to signal CE mark with L4S Queue in L2 is shown in FIG. 12.

FIG. 12 illustrates an example embodiment 410 of congestion control when applying inter-layer service primitives between L2 and L3 to signal a CE mark with L4S queue in L2 (MAC layer). The figure shows interactions between AP 411 and STA 412. Congestion is detected 413 at the MAC layer, with the AP sending an MSDU or A-MSDU 414 to STA 412 which responds with an ACK/BA 416. A MAC-CE.indication primitive 418 is generated, and DL data 420 arrives at the upper layer. An MU-UNITDATA.request 422 is generated. This DL data is enqueued 424 at the MAC layer. The AP transmits an MSDU or A-MSDU 426 which indicates CE to the STA, which upon receipt sets an MU-UNITDATA.indication 428 and an ACK. BA response 432 is sent back to the AP which includes a CE indication, that is noticed 430 at the upper layer.

### 8.1.2. Transit MSDU Between L2 and L3 for ECN Marking

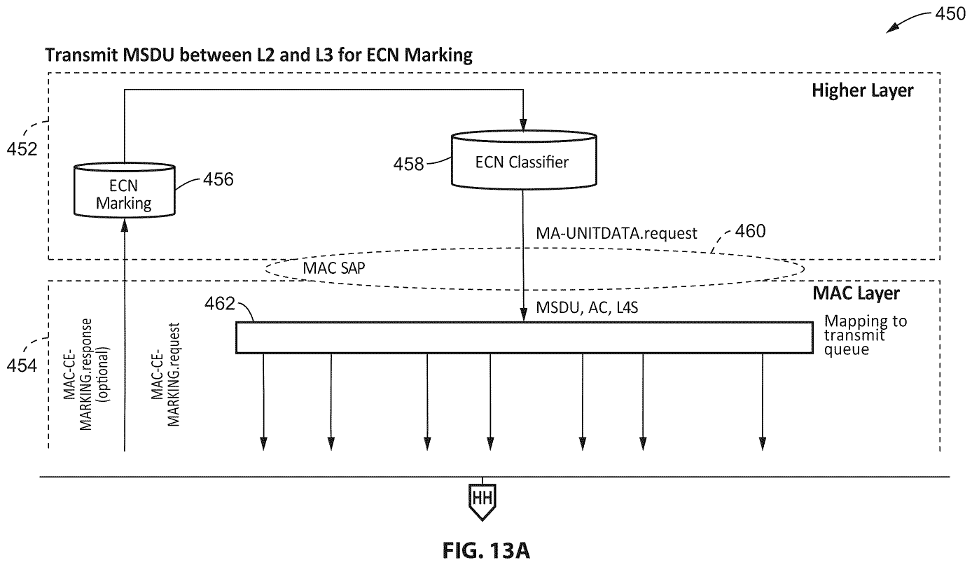

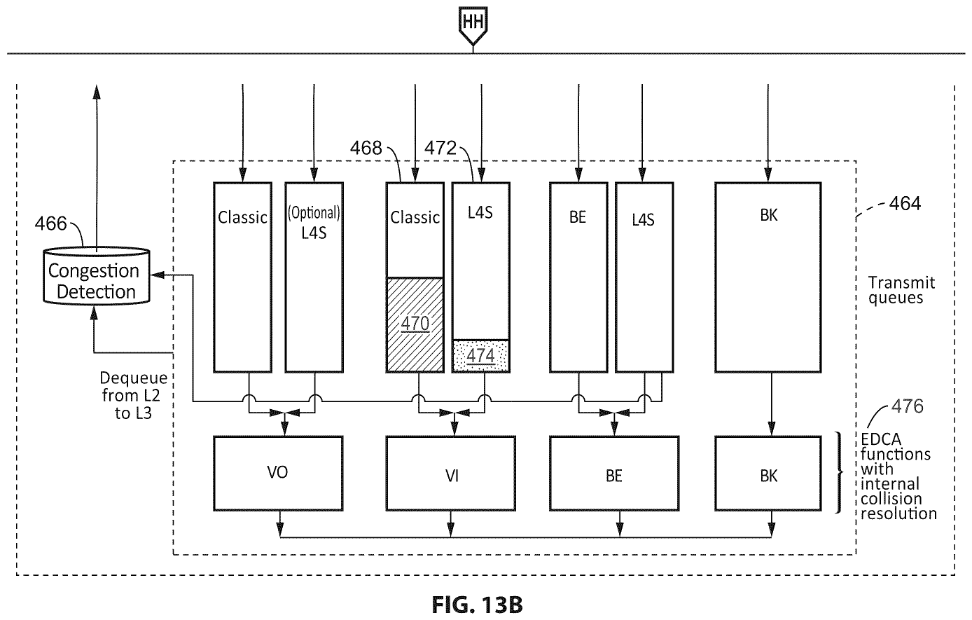

FIG. 13A and FIG. 13B illustrate an example embodiment 450 of inter-layer service primitives between L2 and L3 to transmit an MSDU for CE marking with the L4S Queue in L2.

In FIG. 13A is depicted a higher layer level 452, that is above the MAC layer 454. This higher layer is shown with ECN marking 456 and ECN classifier 458 which connects through a MAC Secure Authentication Protocol (SAP) 460, to the MAC layer 454, shown with mapping 462 to transmit queues 464 in FIG. 13B that are shown with EDCA functions 476 having internal collision resolution with dedicated transmit queues exemplified for VO, VI, BE and BK. Congestion detection 466 is also shown dequeuing from L2 to L3, and using an optional MAC-CE.MARKING.request and MAC-CE.MARKING.response to the detected congestion. In this example a Classic queue 468 is shown with internal queue 470, and an L4S queue 472 is shown with internal queue 474; other queues are depicted by example as Classic, L4S (optional), BE, L4S, and BK.

In at least one embodiment, a new MAC SAP or MLME SAP inter-layer service primitive is described which interacts between the MAC layer and the upper layer. The primitives, exemplified as a MAC-CE-MARKING.request and MAC-CE-MARKING.response as shown in the figure, are designed to achieve the goal of passing the MSDU(s) from the MAC layer to the upper layer for CE marking. Once the upper layer finishes (completes) marking CE of the MSDU(s), it should insert that MSDU(s) back to the MAC queue at the same location.

In at least one embodiment, the parameters of the primitives include but are not limited to the following.

MAC-CE-MARKING.request /MAC-CE-MARKING.response(

source address,
destination address,
data,
priority,

...

SCSID,
L4S identification,
L4S queue dialog token

)

The Source Address (SA) parameter specifies an individual MAC sublayer address of the sublayer entity from which the MSDU came from that is experiencing congestion at the MAC layer. The Destination Address (DA) parameter specifies either an individual or a group MAC sublayer entity address.

The Data parameter specifies the MSDU that is experiencing congestion at the MAC layer. The Priority parameter specifies the priority of the MSDU that is experiencing congestion at the MAC layer. The SCSID parameter indicates the SCSID of the MSDU that is experiencing congestion at the MAC layer. The L4S Identification parameter specifies the MSDU is a L4S LL MSDU, which is classified and enqueued in the L4S queue at the MAC layer. The Queue Dialog Token parameter specifies the dialog token to be utilized for identifying the enqueue and dequeue transactions, which are to maintain the dequeued MSDU, which is for the CE marking at upper layer, and can still be inserted back in the MAC queue at the same place it was before dequeuing.

In at least one embodiment, the MA-UNITDATA.request primitive is described as being the same as that in Section 8.1.1. except that the capability of signaling the upper layer about the congestion in the L4S congestion indication includes the capability of requesting a CE mark of the MSDU(s) transmitted from the MAC layer to the upper layer and the additional parameter of queue dialog token.

MA-UNITDATA.request (

source address,
destination address,
routing information,
data,
priority,
drop eligible,
...
SCSID,
L4S identification,
L4S congestion indication,

L4S queue dialog token
)

The Queue Dialog Token specifies the dialog token to identify the enqueue and dequeue transactions, which is to maintain the dequeued MSDU, which is for CE marking at the upper layer, and which can still be inserted back in the MAC queue at the same location (place) as it was before it was dequeued.

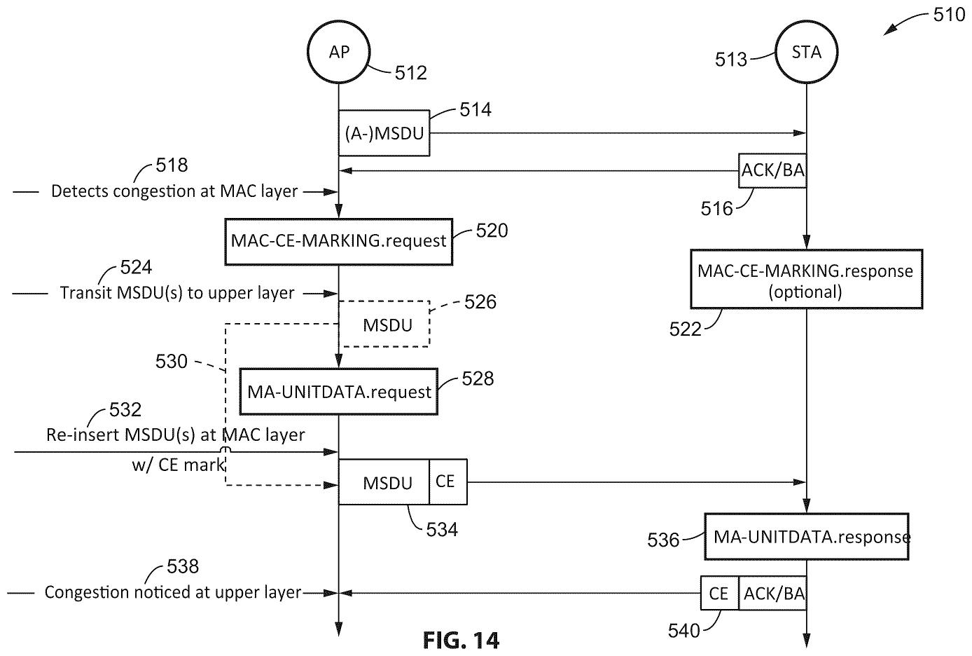

FIG. 14 illustrates an example embodiment 510 of congestion control when applying inter-layer services primitives between L2 and L3 to transmit MSDU for CE mark with L4S Queue in L2. The figure shows interactions between AP 512 and STA 513. An MSDU, or A-MSDU, 514 is transmitted from the AP to STA 513, and the STA responds with an ACK/BA 516. Congestion is detected 518 at the MAC layer, with the AP internally performing a MAC-CE-MARKING.request 520. MSDUs are transited 524 to the upper layer, then an MSDU 526 is optionally sent. The AP makes an MA-UNITDATA.request 528. Reinsertion 532 is requested with MSDU 534 sent with CE, to which the STA 513 responds by performing an MA-UNITDATA.response 536 followed by sending an ACK/BA with CE 540, upon which congestion is noted (detected) 538 on the AP side.

### 8.1.3. Equivalent ECN Marking at L2

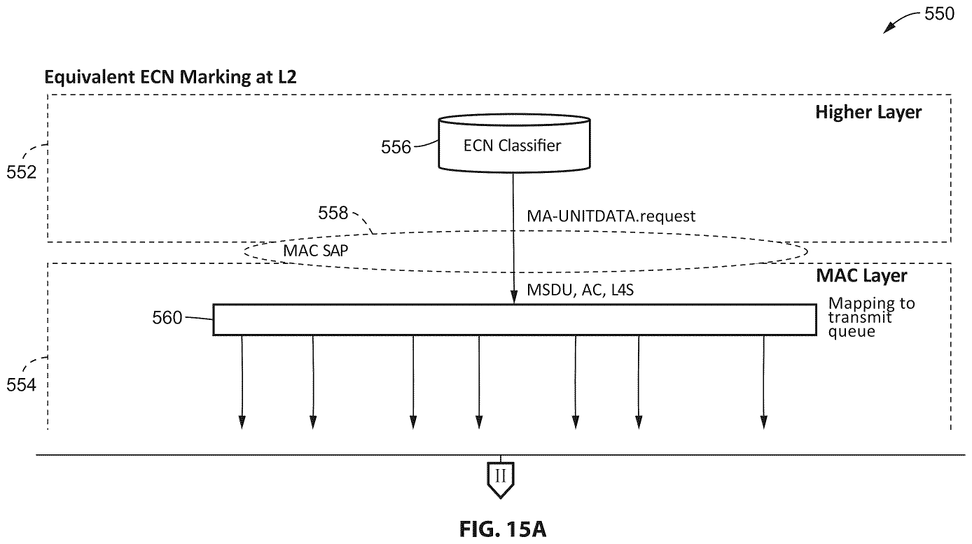

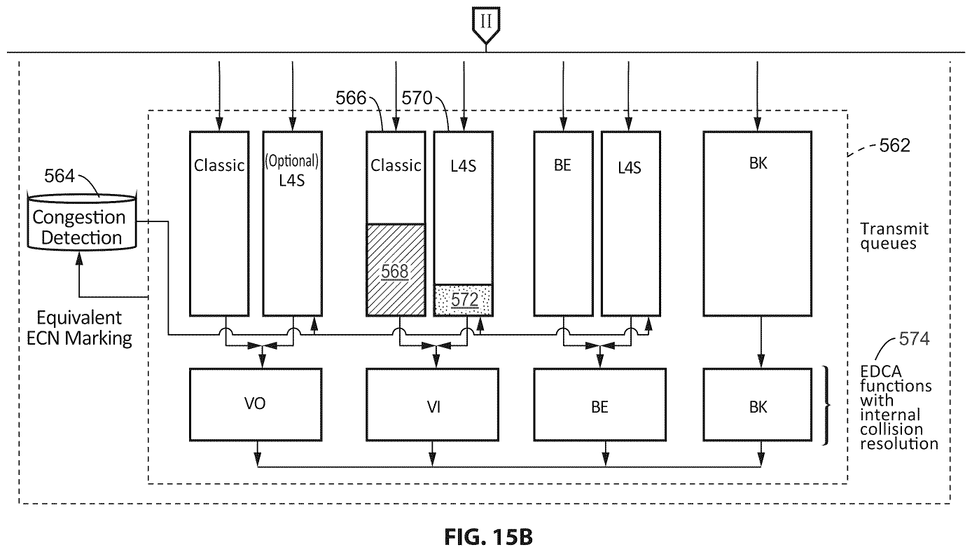

FIG. 15A and FIG. 15B illustrate an example embodiment 550 of Equivalent ECN Marking in L2 with L4S Queue in L2. In FIG. 15A is depicted a higher layer level 552, that is above the MAC layer 554. This higher layer is shown with ECN classifier 556 which connects through a MAC Secure Authentication Protocol (SAP) 558, to the MAC layer 554, shown with mapping 560 to transmit queues 562 in FIG. 15B that are shown with EDCA functions 574 having internal collision resolution with dedicated transmit queues exemplified for VO, VI, BE and BK. Congestion detection 564 is also shown using equivalent ECN marking. In this example a Classic queue 566 is shown with internal queue element 568, and an L4S queue 570 is shown with internal queue element 572; other queues are depicted by example as Classic, L4S (optional), BE, L4S, and BK.

In at least one embodiment, ECN Classifier uses MA-UNITDATA.request primitive to signal the MAC layer about enqueuing the L4S packet and enabling the equivalent ECN Marking as shown in FIG. 15A and FIG. 15B. Thus, a new parameter is used to further enable ECN Marking at L2 to be added in this primitive.

In at least one embodiment, the parameters of the primitive are as follows (with the new parameter marked with an underscore):

MA-UNITDATA.request (

source address,
destination address,
routing information,
data,
priority,
drop eligible,
...
SCSID,
L4S identification,
L4S congestion indication,
L4S equivalent ECN marking at L2

)

The Source Address (SA) parameter specifies an individual MAC sublayer address of the sublayer entity from which the MSDU is being transferred. The Destination Address (DA) parameter specifies either an individual or a group MAC sublayer entity address.

The Routing Information parameter specifies the route for the data transfer. The Data parameter specifies the MSDU to be transmitted by the MAC sublayer entity. The Priority parameter specifies the requested priority of the data transfer. The Drop Eligible parameter indicates whether this MSDU can be discarded in preference to other MSDUs when there are insufficient resources in a STA. The SCSID parameter indicates the SCSID of the MSDU that is being transferred. The L4S Identification parameter specifies the MSDU is a L4S LL MSDU, which is classified and enqueued in the L4S queue at the MAC layer. The L4S Congestion Indication parameter specifies a vector parameter as necessary to manage the L4S congestion, such as L4S congestion level and capability of signaling the upper layer about the congestion. The Congestion Level parameter specifies the maximum number of bytes, or number of MSDUs or A-MSDUs, that if inserted in the MAC queue would start to create congestion issues in that MAC queue. Signaling to the upper layer about the congestion, includes but is not limited to, signaling the current congestion level and request CE mark. The L4S equivalent ECN marking at L2 indicates that L2 can perform equivalent ECN marking at the MAC header to indicate the MDSU is experiencing congestion in the MAC layer.

In at least one other embodiment, the L4S equivalent ECN marking at L2 can also be included in the MA-UNITDATA.indication primitive and the MA-UNITDATA-STATUS.indication primitive.

In at least one embodiment, the equivalent CE mark can be indicated in the MAC header; whereby a CE mark subfield can for example be included in the following fields: (a) using a reserved bit in the QoS Control field; (b) using a reserved bit(s) in the A-Control field of the HT Control filed.

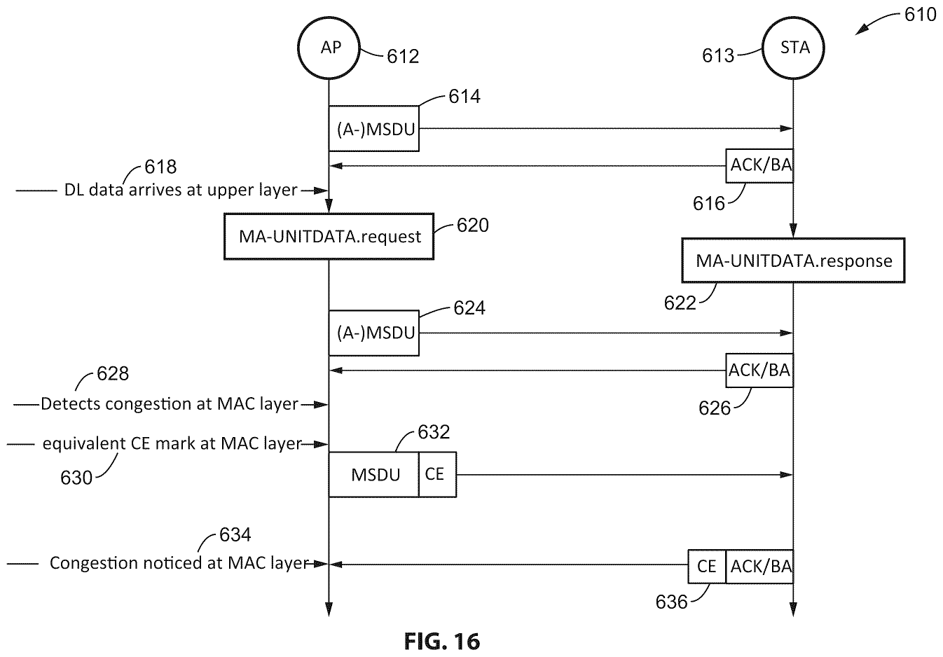

FIG. 16 illustrates an example embodiment 610 of congestion control when applying equivalent ECN Marking in L2 with L4S Queue in L2.

The figure shows interactions between AP 612 and STA 613. An MSDU, or A-MSDU, 614 is transmitted from the AP to STA 613, and the STA responds with an ACK/BA 616. DL data 618 arrives at the upper layer, and the AP sets up an MA-UNITDATA.request 620, shortly after which STA 613 performs an MA-UNITDATA.response 622. The AP sends an MSDU, or A-MSDU, 624, to which STA 613 responds with and ACK/BA 626. Congestion is detected 628 at the MAC layer, and an equivalent CE mark is performed 630 at the MAC layer. The AP transmits an MSDU with CE 632 to the STA, and receives an ACK/BA with CE 636. Congestion is noticed 634 at the MAC layer.

8.1.4. Flow Control Signaling from L2 to Upper Layer

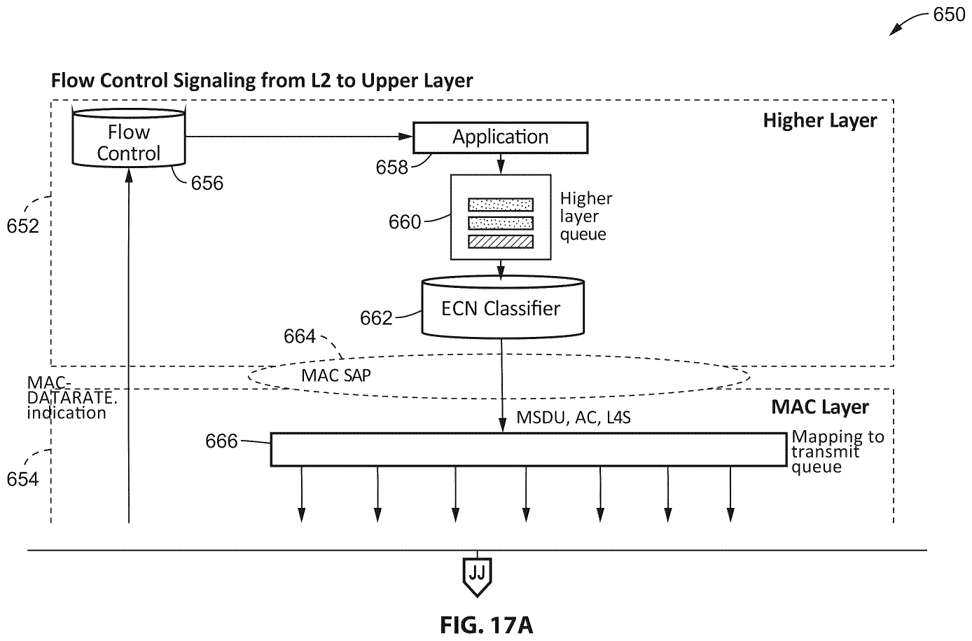

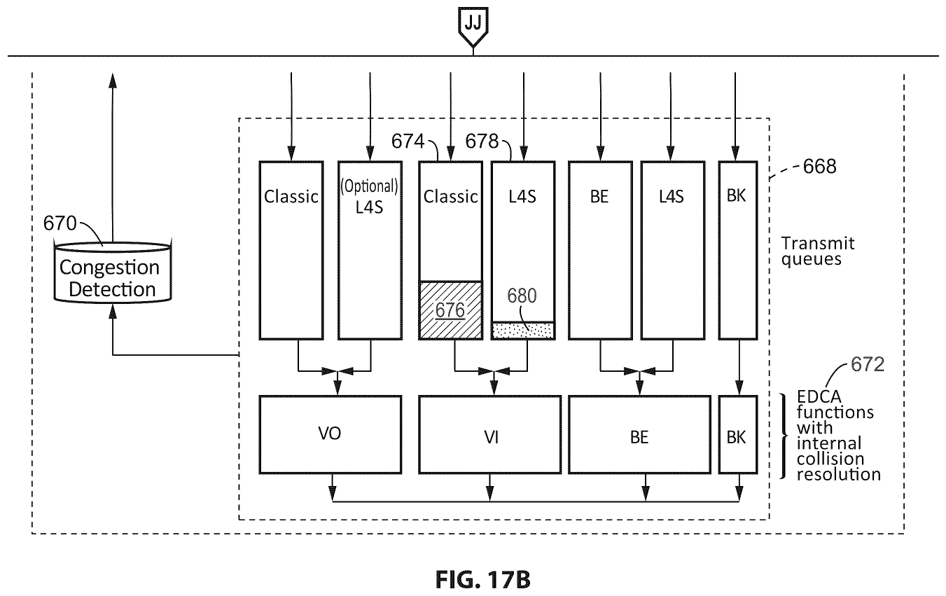

FIG. 17A and FIG. 17B illustrate an example embodiment 650 of inter-layer flow control service primitives between L2 and L3 with L4S Queue in L2. In FIG. 17A is depicted a higher layer level 652, that is above the MAC layer 654. Flow control 656 of this higher layer is shown receiving output from congestion detection 670 that is from the MAC layer. Output from flow control is directed to the Application layer 658, which is connected to a higher layer queue 660, which is in turn connected to an ECN classifier 662 which connects through a MAC Secure Authentication Protocol (SAP) 664, to the MAC layer 654, shown with mapping 666 to transmit queues 668 in FIG. 17B that are shown with EDCA functions 672 having internal collision resolution with dedicated transmit queues exemplified for VO, VI, BE and BK. In this example a Classic queue 674 is shown with internal queue element 676, and an L4S queue 678 is shown with internal queue element 680; other queues are depicted by example as Classic, L4S (optional), BE, L4S, and BK.

In at least one embodiment, a new MAC SAP or MLME SAP inter-layer service primitive is configured that interacts between the MAC layer and the upper layer. As shown in FIG. 17A and FIG. 17B, the primitive, e.g., MAC-DATARATE.indication, is issued by the local MAC to the L3 entity to indicate the flow control related parameters for L3 entity to adjust flow speed. The MAC issues this primitive when the MAC layer experiences congestion. The reception of this primitive by the L3 entity uses the parameters contained in this primitive to estimate the congestion level at MAC layer and thus, adjust the flow control.

In at least one embodiment, the semantics of the primitive provides the following parameters that include, but are not limited to:

MAC-DATARATE.indication (
source address,

destination address,
priority,
...
SCSID,
L4S identification,
L4S congestion indication,

drop rate of classic queue (optional),

data rate,
medium time,
...

)

The Source Address (SA) parameter specifies an individual MAC sublayer address of the sublayer entity from which the MSDU that is experiencing congestion at the MAC layer. The Destination Address (DA) parameter specifies either an individual or a group MAC sublayer entity address.

The Priority parameter specifies the requested priority of the MSDU that is experiencing congestion at the MAC layer. The SCSID parameter indicates the SCSID of the MSDU that is experiencing congestion at the MAC layer. The L4S Identification parameter specifies the MSDU is a L4S LL MSDU, which is classified and enqueued in the L4S queue at the MAC layer. The L4S Congestion Indication parameter specifies vector parameters as necessary for managing L4S congestion, such as L4S congestion level and capability of signaling the upper layer about the level of congestion. The Congestion Level parameter specifies the maximum number of bytes or number of MSDUs or A-MSDUs that if inserted in the MAC queue would cause that MAC queue to experience congestion. The signaling to the upper layer about the congestion includes, but is not limited to, signaling the current congestion level and requesting CE marking.

The Drop Rate parameter of the classic queue specifies the drop rate of the classic queue in L4S queue architecture. The Data Rate parameter specifies the estimated PHY data rate as introduced in Section 8.1.4. The Medium Time parameter specifies the expected medium time for transmitting subsequent MPDU(s).

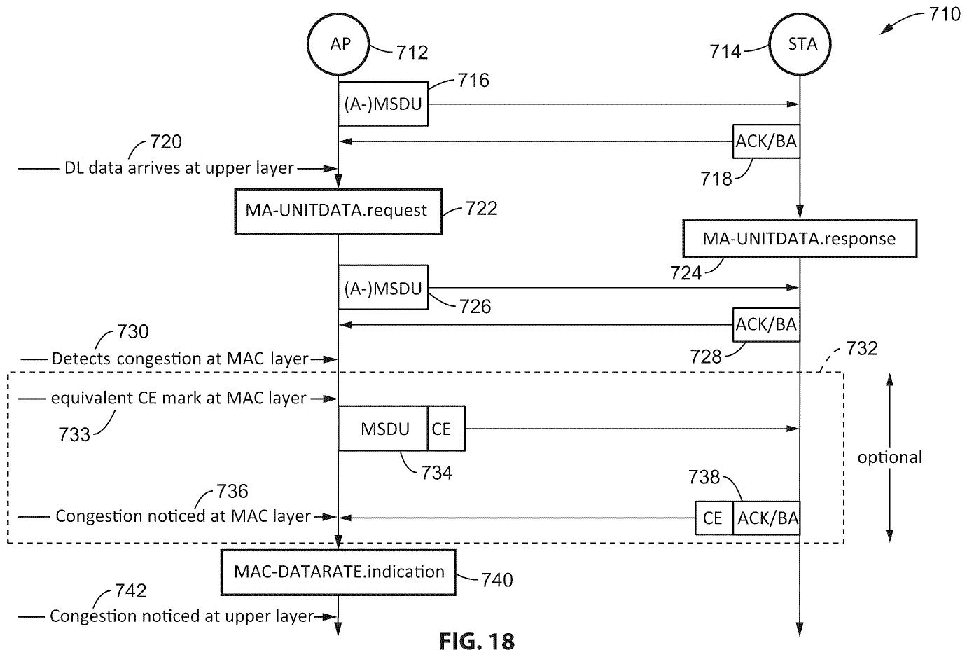

FIG. 18 illustrates an example embodiment 710 of congestion control when applying inter-layer flow control services primitives between L2 and L3 with L4S Queue in L2.

The figure shows interactions between AP 712 and STA 714. An MSDU, or A-MSDU, 716 is transmitted from the AP to STA 714, and the STA responds with an ACK/BA 718. DL data 720 arrives at the upper layer, and the AP sets up an MA-UNITDATA.request 722, shortly after which STA 714 performs an MA-UNITDATA.response 724. The AP sends an MSDU, or A-MSDU 726, to which STA 714 responds with an ACK/BA 728. Congestion is detected 730 at the MAC layer.

In at least one embodiment an optional sequence 730 is performed comprising the following. An equivalent CE mark is performed 733 at the MAC layer with the AP transmitting an MSDU with CE 734 to the STA, and receives an ACK/BA with CE 738. Congestion is noticed 736 at the MAC layer, ending this option sequence.

The AP generates a MAC-DATARATE.indication 740, and congestion is noticed 742 at the upper layer.

8.1.5. Congestion Detection Supportive Signaling from L1 to L2

The EHT PHY TXVECTOR contain MCS, CH_BANDWIDTH, INACTIVE_SUBCHANNELS, RU_ALLOCATION, NUM_STS, STBC, GI_TYPE, and TXOP_DURATION values etc., which is enough to reflect the DATARATE. The PHY TXVECTOR is carried in the PHY-TXSTART.request primitive, which is issued by the MAC sublayer to the PHY entity when the MAC sublayer needs to begin the transmission of a PSDU. In response, the PHY-TXSTART.confirm primitive is issued by the PHY to the local MAC entity to confirm the start of a transmission and to indicate parameters related to the start of the transmission, which includes TIME_OF_DEPARTURE, TIME_OF_DEPARTURE_ClockRate and TX_START_OF_FRAME_OFFSET. In this case, the DATARATE confirmation from the PHY layer to MAC layer at the start of the transmission is not performed in the current specification.

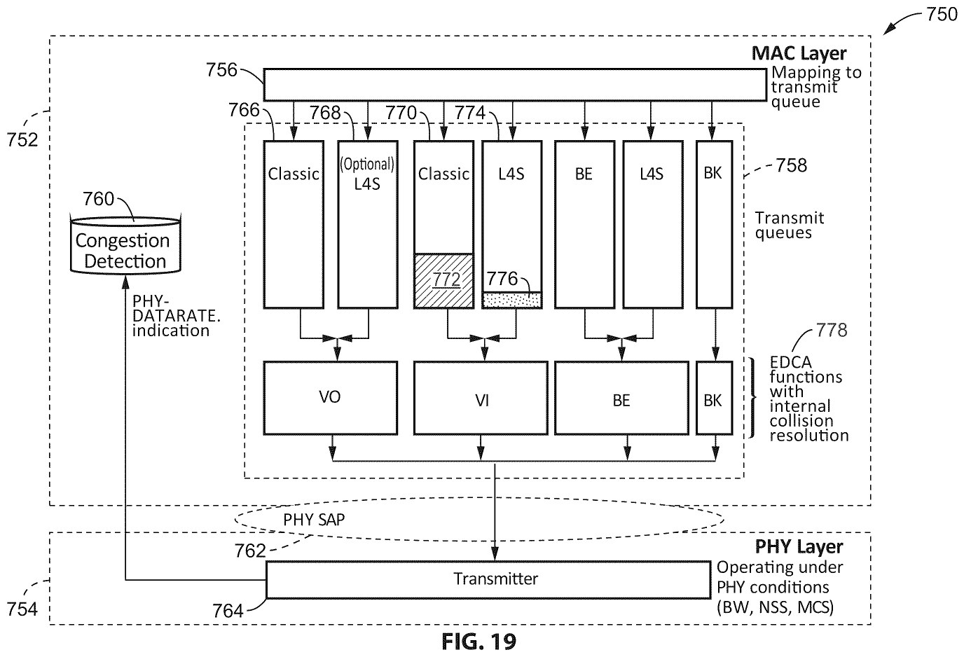

FIG. 19 illustrates an example embodiment 750 of a new PHY SAP or MLME-PLME SAP inter-layer service primitive that interactions between the PHY layer and the MAC layer should be designed.

The MAC layer 752 is shown with mapping 756 to transmit queues 758 that are shown with EDCA functions 776 having internal collision resolution with dedicated transmit queues exemplified for VO, VI, BE and BK. Congestion detection 760 is also shown using equivalent ECN marking. In this example a Classic queue 770 is shown with internal queue element 772, and an L4S queue 774 is shown with internal queue element 776; other queues are depicted by example as Classic 766, as well as L4S (optional) 768, and other queues such as BE, L4S, and BK. A PHY Secure Authentication Protocol (PHY-SAP) 762 is shown connecting the MAC layer to the PHY layer 754 shown with a transmitter 764.

As shown in the figure, the primitive, e.g., PHY-DATARATE.indication, is issued by the PHY layer to the local MAC entity to indicate the DATARATE related parameters at the start of a transmission. The PHY layer issues this primitive in response to every PHY-TXSTART.request primitive issued by the MAC sublayer, together with the PHY-TXSTART.confirm primitive. The reception of this primitive by the MAC entity should use the parameters contained in this primitive to estimate the DATARATE and thus, detect the congestion and process AQM functions in the MAC layer.

In at least one embodiment, the semantics of the primitive provides the following parameters that includes, but is not limited to the following:

PHY-DATARATE.indication (
MCS,
CH_BANDWIDTH,
INACTIVE_SUBCHANNELS,
STBC,
GI_TYPE,
PSDU_LENGTH,
NUM_STS,
TXOP_DURATION,
RU_ALLOCATION,
...
)

8.2. Primitive when L4S Queue is in L2
8.2.1. Signaling ECN Marking from L2 to L3

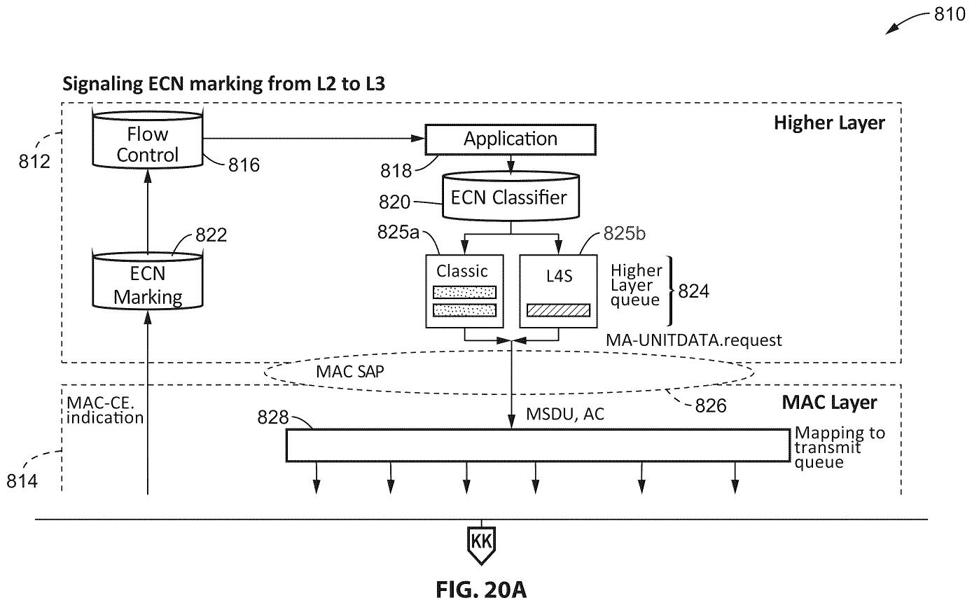

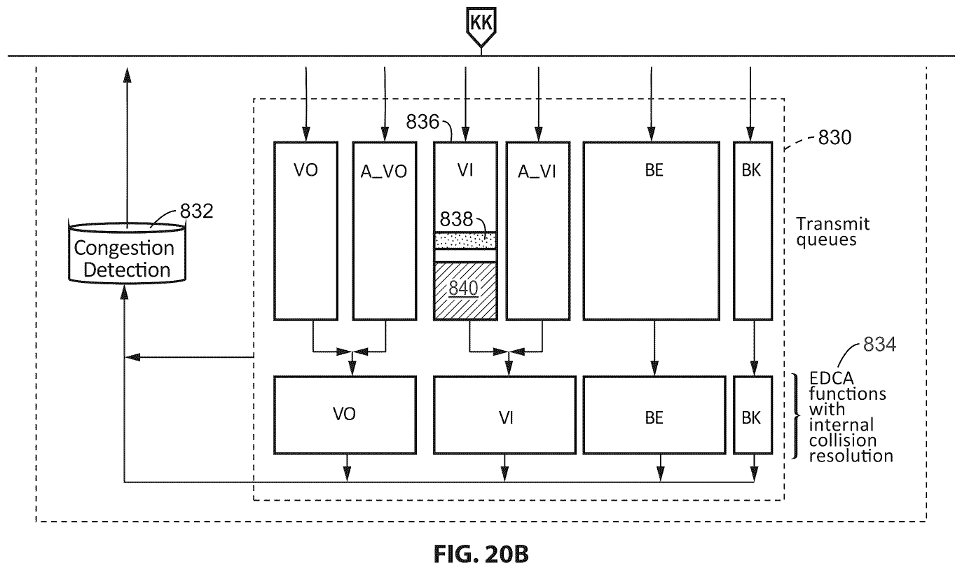

FIG. 20A and FIG. 20A illustrate an example embodiment 810 of a new MAC SAP or MLME SAP inter-layer service primitive that interacts between the MAC layer and the upper layer.

A higher layer level 812 is shown in FIG. 20A above the MAC layer 814. This higher layer is shown receiving Congestion Detection 832 (FIG. 20B) from the MAC layer to ECN marking 822 in upper layer 812 to a Flow Control 816 to the Application 818, which is connected to an ECN Classifier 820 to higher level queues 824, exemplified with a Classic queue 825a, and L4S 825b, and connecting through a MAC Secure Authentication Protocol (SAP) 826, to the MAC layer 814, shown with mapping 828 to transmit queues 830 in FIG. 20B. The transmit queues are shown with a VI queue 836 having internal queue elements 838, 840, as well as other queues such as VO, A_VO, A_VI, BE and BK. EDCA functions 834 are shown with dedicated transmit queues exemplified for VO, VI, BE and BK. Congestion Detection 832 is shown connecting to ECN marking 822 in FIG. 20A.

A primitive is used, such as with an MAC-CE.indication, as shown in the figure, which indicates that congestion was detected in the transfer of data from the MAC to the local upper layer entity called ECN Marking. The receipt of this primitive by the L3 entity causes the ECN Marking entity to mark the CE of the IP header of the subsequent L4S packets before inserting them into the MAC layer. In another embodiment, an L3 management entity can estimate the flow rate that can be inserted into the MAC queue(s).

The MAC-CE.indication primitive provides the following parameters, which include but are not limited to the following:

MAC-CE.indication(

source address,
destination address,
priority,

SCSID,

congestion indication,
data rate,
medium time,
...

)

The Source Address (SA) parameter specifies an individual MAC sublayer address of the sublayer entity from which the MSDU is being transferred. The Destination Address (DA) parameter specifies either an individual or a group MAC sublayer entity address.

The Priority Parameter specifies the requested priority of the data transfer. The SCSID parameter indicates the SCSID of the MSDU. The Congestion Level parameter specifies the maximum number of bytes, or number of MSDUs or A-MSDUs remaining in the MAC queue which could make this MAC queue experience congestion. The data rate parameter specifies the estimated PHY data rate as introduced in Section 8.1.4. The medium time parameter specifies the expected medium time for transmitting subsequent MPDU(s).

In at least one embodiment, the upper layer unit uses the MA-UNITDATA.request primitive to signal MAC layer the enqueue of the L4S packet. Thus, a new parameter is utilized to identify L4S MSDU and should be added in this primitive.

In at least one embodiment, the parameters of the primitives are as follows (with new parameters marked with underscore):

MA-UNITDATA.request (

source address,
destination address,
routing information,
data,
priority,
drop eligible,
...
SCSID,
L4S identification,
L4S congestion indication

)

The Source Address (SA) parameter specifies an individual MAC sublayer address of the sublayer entity from which the MSDU is being transferred. The Destination Address (DA) parameter specifies either an individual or a group MAC sublayer entity address.

The Routing Information parameter specifies the route for the data transfer. The Data Parameter specifies the MSDU to be transmitted by the MAC sublayer entity. The Priority Parameter specifies the requested priority of the data transfer. The Drop Eligible parameter indicates whether this MSDU can be discarded in preference to other MSDUs when there are insufficient resources in a STA.

For the MSDU with L4S identification, it should not be processed according to the drop eligible parameter and should be processed based on the L4S congestion indication.

The SCSID parameter indicates the SCSID of the MSDU that is being transferred. The L4S Identification parameter specifies the MSDU as L4S LL data, which indicates that this MSDU should not be dropped. The L4S congestion indication specifies a vector parameter as needed to manage the congestion of the L4S MSDU level and the capability of signaling the upper layer regarding congestion.

The congestion level specifies the maximum number of bytes or number of MSDUs or A-MSDUs which if inserted in the MAC queue would cause that MAC queue to begin experiencing congestion.

The signaling to the upper layer indicating about congestion includes, but is not limited to signaling the current congestion level and requests for a CE mark.

In at least one embodiment, the L4S identification and L4S congestion indication can also be included in the MA-UNITDATA.indication primitive and the MA-UNITDATA-STATUS.indication primitive.

In at least one embodiment, the indication of congestion control when applying inter-layer services primitives, between L2 and L3, signals the CE mark with L4S queue above L2 is the same as that shown in FIG. 12.

### 8.2.2. Transit MSDU Between L2 and L3 for ECN Marking

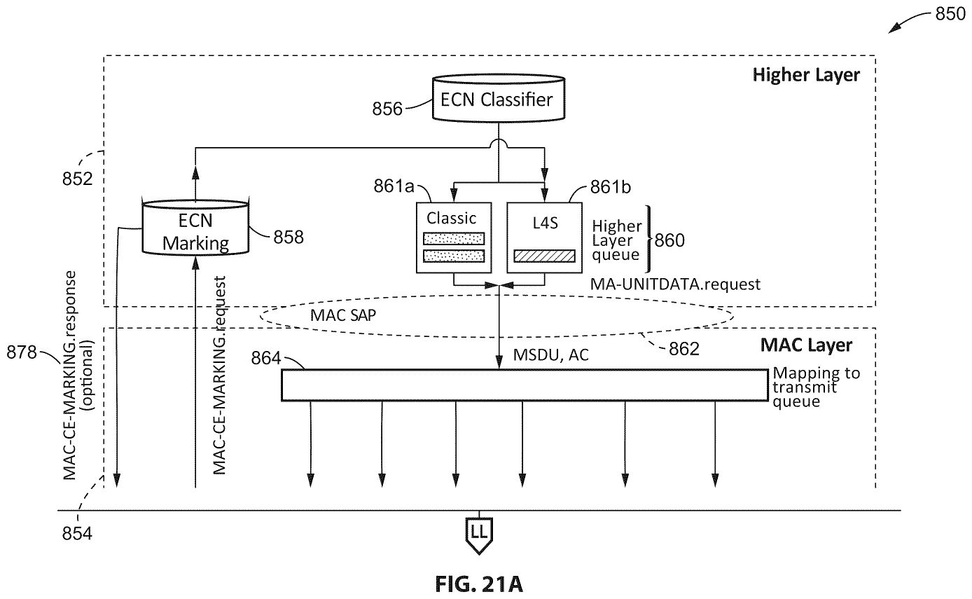

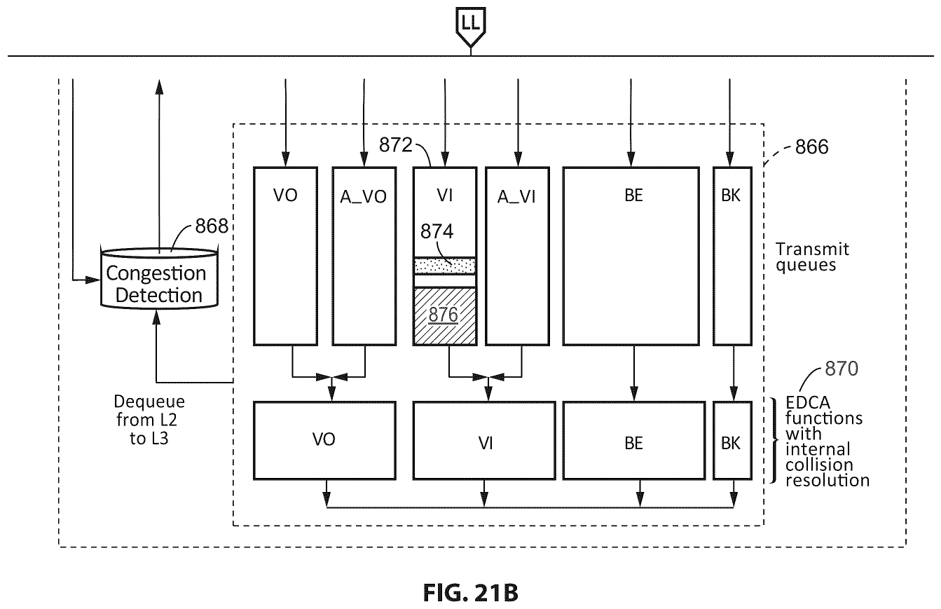

FIG. 21A and FIG. 21B illustrate an example embodiment 850 of inter-layer service primitives between L2 and L3 to transmit an MSDU for CE marking with L4S Queue above L2.

In FIG. 21A a higher layer level 852 is shown above the MAC layer 854. This higher layer is shown with ECN marking 858 going directly to higher level queues 860, exemplified with a Classic queue 861a, and L4S 861b. The ECN Classifier 856 in this higher layer is also directly connected to these higher layer queues.

Higher layer 852 is connecting through MAC Secure Authentication Protocol (SAP) 862, to the MAC layer 854, shown with mapping 864 to transmit queues 866 in FIG. 21B. The transmit queues are shown with a VI queue 872 having internal queue elements 874, 876, as well as other queues such as VO, A_VO, A_VI, BE and BK. EDCA functions 870 are shown with its dedicated transmit queues for VO, VI, BE, and BK. The MAC layer 854 is also shown with Congestion Detection 868 which communicates with ECN Marking 858 in the higher layers, which may optionally communicate, such as using a MAC-CE-MARKING.response to Congestion Detection 868.

In at least one embodiment, a new MAC SAP or MLME SAP inter-layer service primitive is provided that interacts between the MAC layer and the upper layer. The primitives e.g., MAC-CE-MARKING.request and MAC-CE-MARKING.response, were shown in FIG. 21A and FIG. 21B, are designed to achieve the goal of passing the MSDU(s) from the MAC layer to the upper layer for CE marking. Once the upper layer finishes marking the CE of that MSDU(s), it is inserted back into the MAC queue at the same place from which it was dequeued.

In at least one embodiment, the parameters of the primitives include, but are not limited to, the following:

MAC-CE-MARKING.request /MAC-CE-MARKING.response(

source address,
destination address,
data,
priority,

...

SCSID,
L4S identification,
L4S queue dialog token

)

The Source Address (SA) parameter specifies an individual MAC sublayer address of the sublayer entity from which the MSDU is experiencing congestion at the MAC layer. The Destination Address (DA) parameter specifies either an individual or a group MAC sublayer entity address.

The Data parameter specifies the MSDU that is experiencing congestion at the MAC layer. The Priority parameter specifies the priority of the MSDU that is experiencing congestion at the MAC layer. The SCSID parameter indicates the SCSID of the MSDU that is experiencing congestion at the MAC layer. The L4S identification parameter specifies the MSDU as a L4S LL MSDU, which is classified and enqueued in the L4S queue at the upper layer.

The queue dialog token specifies the dialog token to identify the enqueue and dequeue transactions, which is to maintain the dequeued MSDU, which is for CE marking at the upper layer, so that it can be inserted back in the MAC queue at the same place that it was before it was dequeued.

In at least one embodiment, the MA-UNITDATA.request primitive can be designed the same at that in Section 8.2.1., except that the capability of signaling the upper layer about congestion in the L4S congestion indication includes the capability of requesting CE marking of the MSDU(s) be transmitted from the MAC layer to the upper layer and the additional parameter of queue dialog token.

MA-UNITDATA.request (

source address,
destination address,
routing information,
data,
priority,
drop eligible,
...
SCSID,
L4S identification,
L4S congestion indication,

L4S queue dialog token
)

The Queue Dialog Token specifies the dialog token to identify the enqueue and dequeue transactions, which is to maintain the dequeued MSDU, which is for CE marking at the upper layer, so that it can still be inserted back in the MAC queue at the same place that it was before it was dequeued.

In at least one embodiment, the illustration of congestion control when applying Inter-layer service primitives between L2 and L3 to transmit an MSDU for CE marking with the L4S Queue above L2 the is the same as that shown in FIG. 14.

### 8.2.3. Equivalent ECN Marking at L2

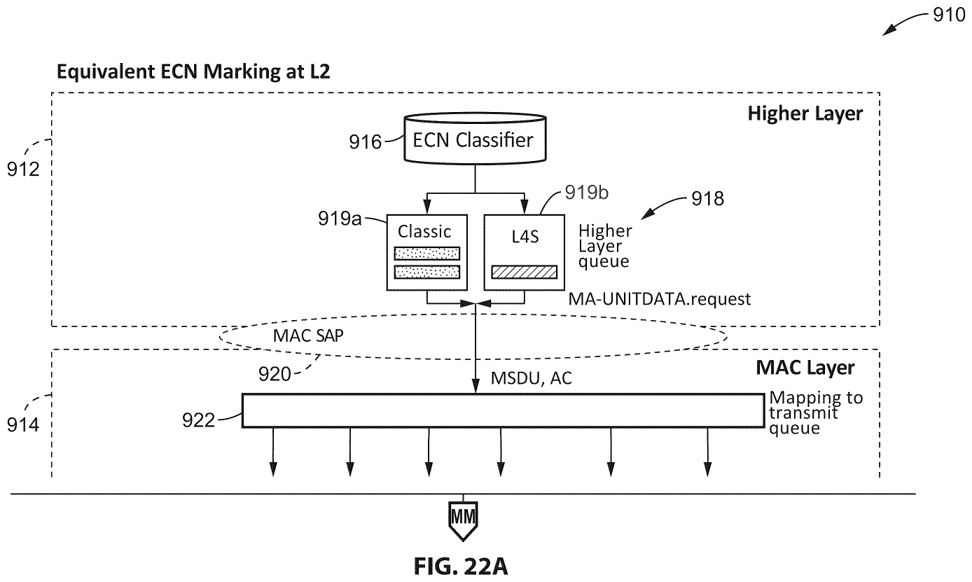

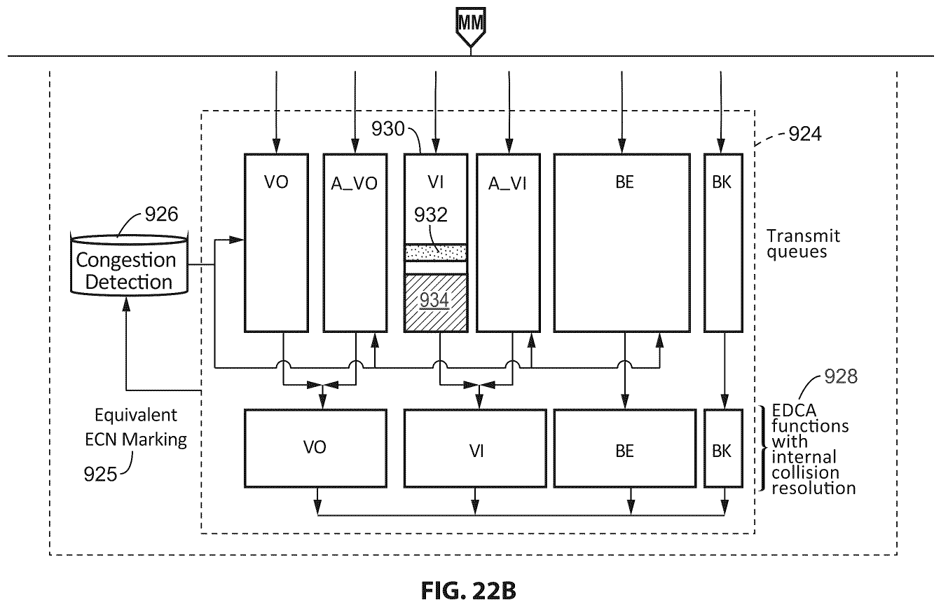

FIG. 22A and FIG. 22B illustrate an example embodiment 910 of Equivalent ECN Marking in L2 with L4S Queue above L2.

A higher layer level 912 is shown above the MAC layer 914. This higher layer is shown with ECN Classifier 916 connecting to higher level queues 918, exemplified with a Classic queue 919a, and L4S 919b, and connecting through a MAC Secure Authentication Protocol (SAP) 920, to the MAC layer 914, shown with mapping 922 to transmit queues 924 in FIG. 22B. By way of example and not limitation, the transmit queues are shown with a VI queue 930 having internal queue elements 932, 934, as well as other queues, such as VO, A_VO, A_VI, BE and BK. EDCA functions 928 are shown with its dedicated transmit queues exemplified as VO, VI, BE and BK. Congestion Detection 926 is shown receiving equivalent ECN marking 925.

In at least one embodiment, the ECN Classifier uses an MA-UNITDATA.request primitive to signal the MAC layer about the enqueuing of the L4S packet and enable the equivalent ECN Marking, as shown in the figure. Thus, this new parameter further enables ECN Marking at L2 in this primitive.

In at least one embodiment, the parameters of the primitive are as follows (with new parameters marked with underscores):

MA-UNITDATA.request (

source address,
destination address,
routing information,
data,
priority,
drop eligible,
...
SCSID,
L4S identification,
L4S congestion indication,
L4S equivalent ECN marking at L2

)

The Source Address (SA) parameter specifies an individual MAC sublayer address of the sublayer entity from which the MSDU is being transferred. The Destination Address (DA) parameter specifies either an individual or a group MAC sublayer entity address.

The Routing Information parameter specifies the route for the data transfer. The Data parameter specifies the MSDU to be transmitted by the MAC sublayer entity. The Priority parameter specifies the requested priority of the data transfer. The Drop Eligible parameter indicates whether this MSDU can be discarded in preference to other MSDUs when there are insufficient resources available at a STA. The SCSID parameter indicates the SCSID of the MSDU that is being transferred. The L4S Identification parameter specifies the MSDU is a L4S LL MSDU, which is classified and enqueued in the L4S queue at the upper layer. The L4S Congestion indication parameter specifies a vector parameter as needed to manage L4S congestion, such as the L4S congestion level and the capability of signaling the upper layer about congestion. The Congestion Level parameter specifies the maximum number of bytes, or number of MSDUs or A-MSDUs, that if inserted in the MAC queue would cause that MAC queue to experience congestion. The signaling to the upper layer about the congestion includes, but is not limited to signaling the current congestion level and requesting CE marking. The L4S equivalent ECN marking at L2 indicate that L2 can provide equivalent ECN marking at the MAC header to indicate that the MDSU is experiencing congestion in the MAC layer.

In another embodiment, the L4S equivalent ECN marking at L2 can also be included in the MA-UNITDATA.indication primitive and the MA-UNITDATA-STATUS.indication primitive.

In at least one embodiment, the equivalent CE mark can be indicated in the MAC header; whereby a CE mark subfield can be included in the following manner: (a) using a reserved bit in QoS Control field, or (b) using a reserved bit(s) in the A-Control field of the HT Control field.

In at least one embodiment, the illustration of congestion control when applying Equivalent ECN Marking in L2 with L4S Queue above L2 can be the same as that shown in FIG. 16.

In at least one embodiment, the equivalent CE mark as discussed in Sections 8.1.3 and 8.2.3 can be indicated in the MAC header in the transmitted MSDU that experienced congestion and the acknowledgement frame as the response of the reception of the MSDU with equivalent CE mark. Which means a CE mark subfield can be included in the following fields: (a) using reserved bit in QoS Control field; (b) using reserved bit(s) in A-Control field of the HT Control field.

8.2.4. Flow Control Signaling from L2 to Upper Layer

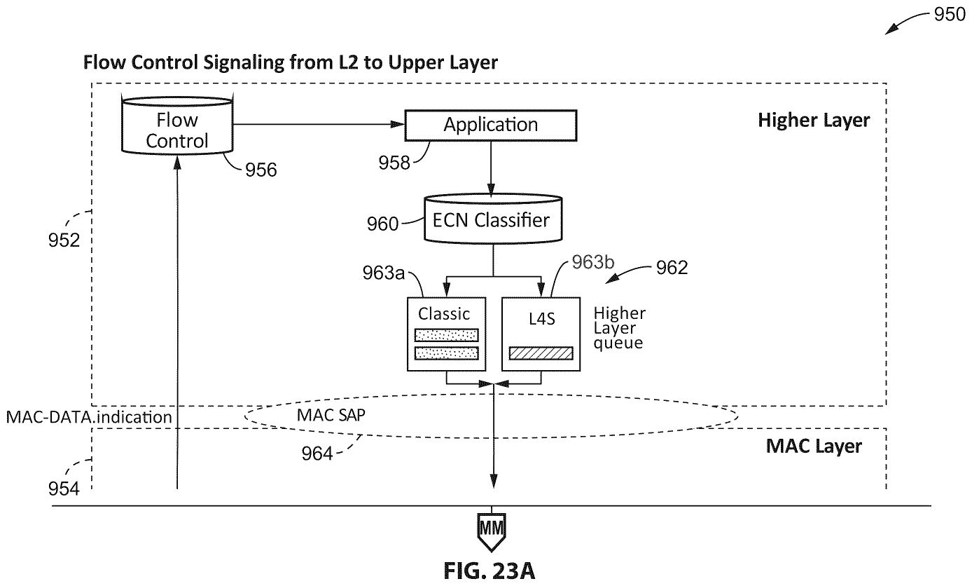

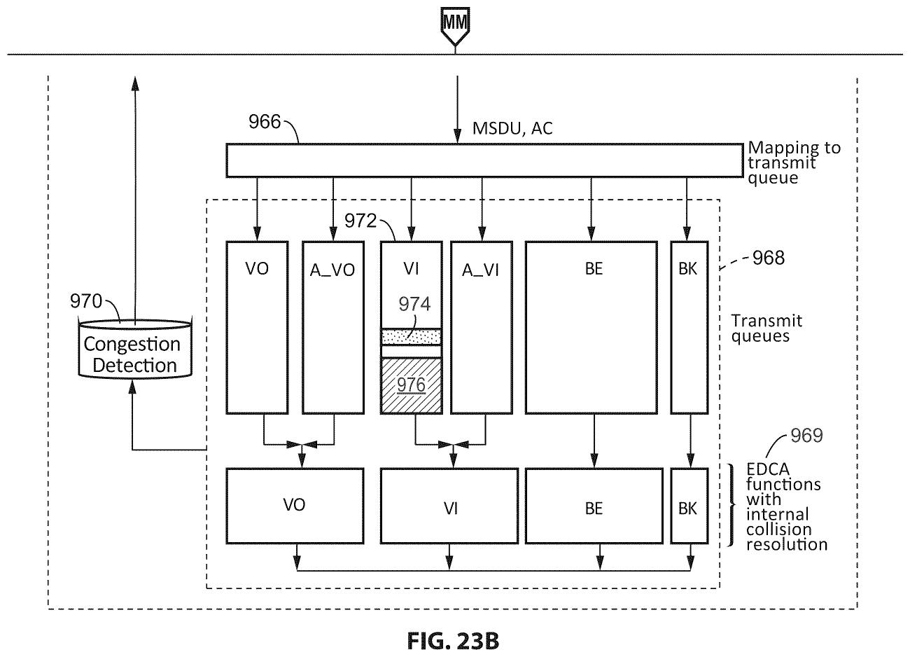

FIG. 23A and FIG. 23B illustrate an example embodiment 950 of inter-layer flow control services primitives between L2 and L3 with L4S Queue above L2.

A higher layer level 952 is shown above the MAC layer 954. This higher layer is shown with Flow Control 956 to Application 958 to an ECN classifier 960 to higher level queues 962, exemplified with a Classic queue 963a, and L4S 963b, and connecting through a MAC Secure Authentication Protocol (SAP) 964, to the MAC layer 954 shown with mapping 966 in FIG. 23B to transmit queues 968. The transmit queues are exemplified with a VI queue 972 having internal queue elements 974, 976, as well as other queues such as VO, A_VO, A_VI, BE and BK. EDCA functions 969 are shown with its dedicated transmit queues exemplified with VO, VI, BE and BK. Congestion Detection 970 is shown which communicates with Flow Control 956 in the upper layer 952.

In at least one embodiment, a new MAC SAP or MLME SAP inter-layer service primitive is created that interacts between the MAC layer and the upper layer. As shown in the figure, the primitive, such as a MAC-DATARATE.indication, is issued by the local MAC to the L3 entity to indicate flow control related parameters for the L3 entity to adjust flow speed. The MAC issues this primitive when the MAC layer experiences congestion. The reception of this primitive by the L3 entity should use the parameters contained in this primitive to estimate the congestion level at the MAC layer and thus, adjust the flow control.

In at least one embodiment, the semantics of the primitive provides the parameters that include but are not limited to the following:

MAC-DATARATE.indication (
source address,

destination address,
priority,
...
SCSID,
L4S identification,
L4S congestion indication,

drop rate,

data rate,
medium time,
...

)

The Source Address (SA) parameter specifies an individual MAC sublayer address of the sublayer entity from which the MSDU that is experiencing congestion at the MAC layer. The Destination Address (DA) parameter specifies either an individual or a group MAC sublayer entity address.

The Priority parameter specifies the requested priority of the MSDU that is experiencing congestion at the MAC layer. The SCSID parameter indicates the SCSID of the MSDU that is experiencing congestion at the MAC layer. The L4S Identification parameter specifies the MSDU is a L4S LL MSDU, which is classified and enqueued in the L4S queue at the upper layer. The L4S Congestion Indication specifies a vector parameter as needed to manage the L4S congestion, such as L4S congestion level and capability of signaling the upper layer about the congestion.

The Congestion Level parameter specifies the maximum number of bytes or number of MSDUs or A-MSDUs that can be inserted in the MAC queue before it experiences congestion.

The signaling sent to the upper layer about congestion includes but is not limited to signaling regarding the current congestion level and requesting a CE mark. The Drop Rate parameter specifies the drop rate of the MAC transmit queue. The Data Rate parameter specifies the estimated PHY data rate as introduced in Section 8.1.4. The Medium Time parameter specifies the expected medium time for transmitting subsequent MPDU(s). In at least one embodiment, the illustration of congestion control when applying Inter-layer flow control services primitives between L2 and L3 with L4S Queue above L2 can be the same as that shown in FIG. 18.

### 9. SCS Design

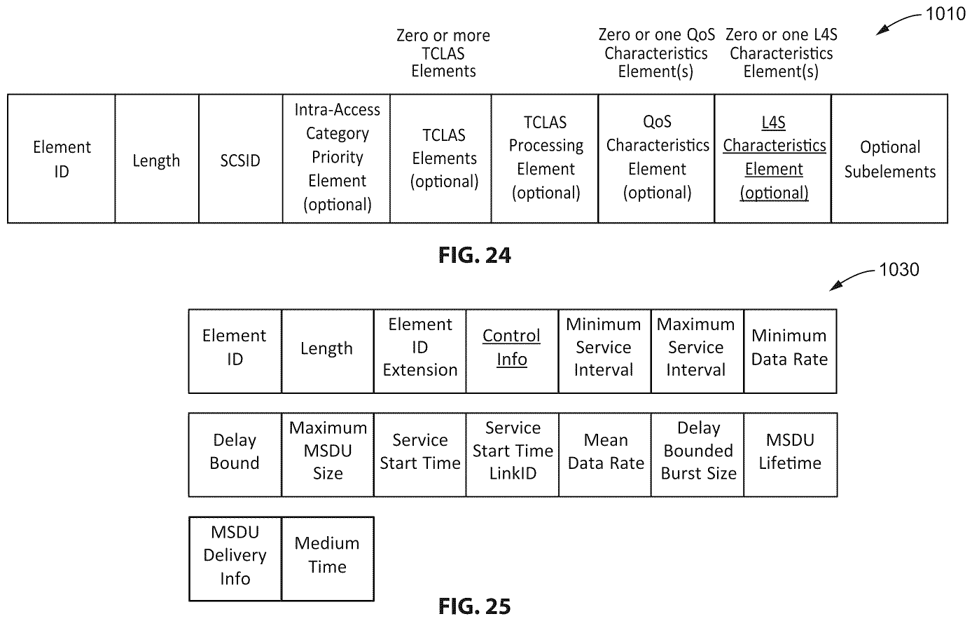

FIG. 24 illustrates an example embodiment 1010 of an SCS Descriptor element format. The descriptor element contains zero or more TCLAS elements, zero or more QoS Characteristics Elements, and zero or more L4S Characteristics Elements. The subfields are exemplified in the figures as: Element ID, Length, SCSID, Intra-Access Category Priority Element (optional), TCLAS Elements (optional), TCLAS Processing Element (optional), QoS Characteristics Element (optional), L4S Characteristics Element (optional), and Optional Sub elements.

In at least one embodiment, the SCS Descriptor element can carry: (a) only the QoS characteristic element, in which case the negotiating devices should attempt to meet the QoS characteristic of the SCS flows; or (b) only the L4S characteristic element, in which case the negotiating devices should attempt to meet the L4S characteristic of the L4S flows; or (c) both the QoS characteristic element and the L4S characteristic element, in which case the negotiating devices should attempt to meet both the QoS characteristic of the SCS flows and the L4S characteristic of the L4S flows.

FIG. 25 illustrates an example embodiment 1030 of an QoS Characteristics element format. The subfields are exemplified in the figure as: Element ID, Length, Element ID Extension, Control Info, Minimum Service Interval, Maximum Service Interval, Minimum Data Rate, Delay Bound, Maximum MSDU size, Service Start Time, Service Start Time LinkID, Mean Data Rate, Delay Bounded Burst Size, MSDU Lifetime, MSDU Delivery Information, and Medium Time.

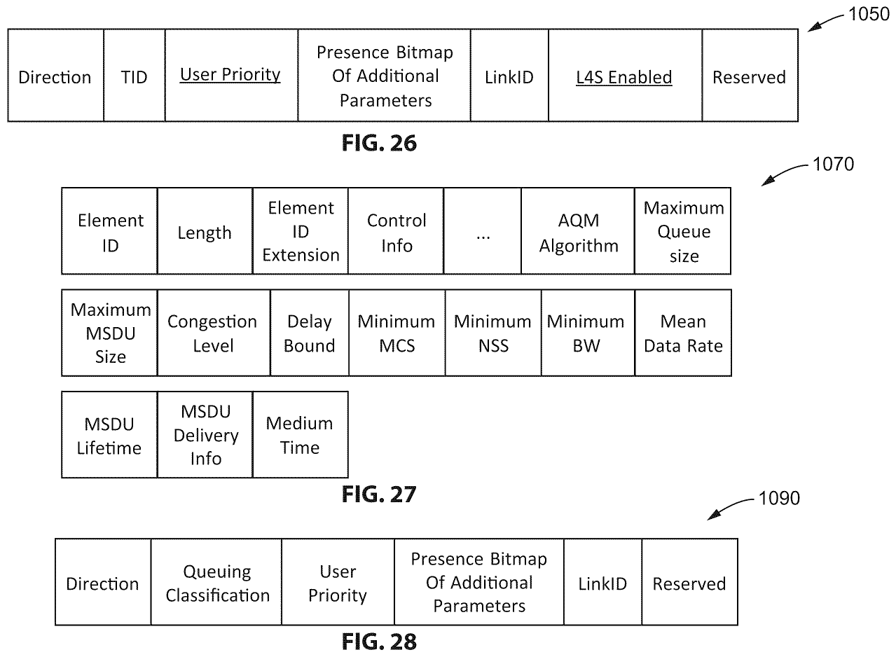

FIG. 26 illustrates an example embodiment 1050 of Control Info field format of QoS Characteristics element. In at least one embodiment, an additional “L4S Enabled” subfield should be included in the Control Info field format (FIG. 26) of the QoS Characteristics element (FIG. 25), to indicate whether the negotiating device supports the coexistence of SCS flow and L4S flow. For example, if the “L4S Enabled” is set to higher level “1”, it indicates that the device supports coexistence of both SCS flow and L4S flow; otherwise it is set to lower level “0”.

The subfields are exemplified in the figure as: Direction, TID, User Priority, Presence Bitmap of Additional Parameters, Link ID, L4S Enabled, and Reserved.

FIG. 27 illustrates an example embodiment 1070 of L4S Characteristics element format. The subfields are exemplified in the figure as: Element ID, Length, Element ID Extension, Control Info, . . . , AQM Algorithm, Maximum Queue Size, Maximum MSDU size, Congestion Level, Delay Bound, Minimum MCS, Minimum NSS, Minimum Bandwidth (BW), Mean Data Rate, MSDU Lifetime, MSDU Delivery Information, and Medium Time.

The AQM Algorithm field indicates the negotiated AQM algorithm between the negotiation peer. The details of AQM algorithms are not within the scope of this disclosure.

The Maximum Queue size field contains an unsigned integer that indicates the maximum size of the L4S queues belonging to the device sending this element. The value 0 is reserved.

The Maximum MSDU Size field contains an unsigned integer that specifies the maximum size of an MSDU belonging to the L4S traffic flow described by this element. The value 0 is reserved.

The Congestion Level contains an unsigned integer that specifies the maximum amount of MSDUs or A-MSDUs of the L4S flow described by this element that are not marking CE and are stored in the L4S queue at the same time. The value 0 is reserved.

The Delay Bound field contains an unsigned integer that specifies the maximum amount of time targeted to transport an MSDU or A-MSDU belonging to the traffic flow described by this element.

The Minimum MCS field contains an unsigned integer that indicates the minimum MCS necessary to serve the L4S traffic flow described by this element. The value 0 is reserved.

The Minimum NSS field contains an unsigned integer that specifies the minimum Number of Spatial Streams that are needed to serve the L4S traffic flow described by this element. The value 0 is reserved.

The Minimum Bandwidth field contains an unsigned integer that specifies the minimum bandwidth required to serve the L4S traffic flow described by this element. The value 0 is reserved.

The Mean Data Rate field indicates the average data rate specified at the MAC SAP in units of kilobits per second, for transporting of MSDUs or A-MSDUs belonging to the traffic flow described by this element. The value 0 is reserved.

The MSDU Lifetime field contains an unsigned integer that specifies the maximum amount of time, since the arrival of the MSDU at the MAC data service interface, beyond which the MSDU is not useful even if received by the received by the receiver.

The MSDU Delivery Info field contains the MSDU Delivery information, such as the MSDU Delivery Ratio subfield and the MSDU Count Exponent subfield.

The Medium Time field contains an unsigned integer that specifies the medium time, requested by the STA as the average medium time needed in each second.

FIG. 28 illustrates an example embodiment 1090 of Control Info field format of L4S Characteristics element.

In at least one embodiment, the L4S Characteristic element as shown in FIG. 27 is a reference for the UHR AP's scheduling for L4S, which should contain subfields including: Element ID, Length, and Element ID Extension subfields as other elements.

The structure of Control Info field format of L4S Characteristics element is defined in FIG. 28. Where the subfields of the Control Info field are defined as follows.

The Direction subfield specifies the direction of data described by this element. By way of example and not limitation, the value 0 indicates UL, value 1 indicates DL, value 2 indicates Direct link, and the value 3 indicates Reserved.

The Queuing Classification subfield indicates a classification value of L4S LL traffic and the mapped queue corresponding to the new L4S dual queue architecture.

The User Priority subfield contains the user priority value of the data frames that are described by this element. The L4S LL can utilize a different user priority value (other than 0-7) to identify itself from classic traffics.

The Presence Bitmap of Additional Parameters subfield contains a bitmap in which the i-th entry of the bitmap is set to a first state, “1” if the i-th field starting from a specific field of the L4S Characteristic element, such as the Maximum MSDU Size field is present in this element.

The LinkID subfield contains the link identifier that corresponds to the link for which the direct link transmissions are going to occur. This field is reserved if the Direction subfield is equal to any value except 2.

### 10. General Scope of Embodiments

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula (e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

An apparatus for communication in a wireless network, the apparatus comprising: (a) a wireless station (STA) configured with a queuing architecture supporting low latency low loss scalable throughput (L4S) and dual queue active queue management (AQM) in which queues for both L4S streams and classic streams are contained in the medium access control (MAC) layer, with at least one of these queues configured with more than one internal queue, to which different L4S packets and other packet types are retained in different internal queues within the MAC transmit queues; (b) wherein said STA operates as either an access point (AP) or non-AP STA; (c) at least one processor of said STA and a non-transitory memory storing instructions executable by the at least one processor for wirelessly communicating from the STA with other STAs on an IEEE 802.11 wireless local area network (WLAN); and (d) wherein said instructions, when executed by the at least one processor, perform steps of a wireless communications protocol, comprising: (d)(i) maintaining queues for both L4S streams and classic streams in the medium access control (MAC) layer, wherein each MAC queue is configured for buffering L4S packets and classical packets in separate queues and queues having internal queues for buffering different packet types; (d)(ii) performing explicit congestion notification (ECN) to signal congestion without dropping packets, allowing devices to adjust their transmission rates proactively; and (d)(iii) wherein said ECN comprises detecting congestion at the MAC or physical (PHY) layer which is communicated by the MAC layer sending cross-link primitives to upper layers to communicate congestion information, data rate indications, marking packets to indicate that contention has been experienced, requests for L4S packet enqueuing, toward supporting L4S features in the MAC layer, which reduce latency of L4S packet transmissions.

An apparatus for communication in a wireless network, the apparatus comprising: (a) a wireless station (STA) configured with a queuing architecture supporting low latency low loss scalable throughput (L4S) and dual queue active queue management (AQM) in which queues for both L4S streams and classic streams are contained in the medium access control (MAC) layer, and one of more of these queues are configured with more than one internal queue, to which different L4S packets and other packet types are retained in different internal queues within the MAC transmit queues; (b) wherein said STA operates as either an access point (AP) or non-AP STA; (c) at least one processor of said STA and a non-transitory memory storing instructions executable by the at least one processor for wirelessly communicating from the STA with other STAs on an IEEE 802.11 wireless local area network (WLAN); and (d) wherein said instructions, when executed by the at least one processor, perform steps of a wireless communications protocol, comprising: (d)(i) maintaining queues for both L4S streams and classic streams in the medium access control (MAC) layer, wherein each MAC queue is configured for buffering L4S packets and classical packets in separate queues and queues having internal queues for buffering different packet types; (d)(ii) further comprising maintaining one or more higher levels packet queues in the upper layers, which buffer packets before they are directed into the MAC queues; (d)(iii) performing explicit congestion notification (ECN) to signal congestion without dropping packets, allowing devices to adjust their transmission rates proactively; and (d)(iv) wherein said ECN comprises detecting congestion at the MAC or physical (PHY) layer which is communicated by the MAC layer sending cross-link primitives to upper layers to communicate congestion information, data rate indications, marking packets to indicate that contention has been experienced, requests for L4S packet enqueuing, toward supporting L4S features in the MAC layer, which reduce latency of L4S packet transmissions.

A method for communicating in a wireless network, comprising: (a) supporting low latency low loss scalable throughput (L4S) and dual queue active queue management (AQM) in a wireless station (STA) having a queuing architecture which has queues for both L4S streams and classic streams contained in the medium access control (MAC) layer, wherein at least one of these queues are configured with more than one internal queue, to which different L4S packets and other packet types are retained in different internal queues within the MAC transmit queues for communicating on an IEEE 802.11 wireless local area network (WLAN); (b) maintaining the queues for both L4S streams and classic streams in the medium access control (MAC) layer, wherein each MAC queue is configured for buffering L4S packets and classical packets in separate queues and queues having internal queues for buffering different packet types; (c) performing explicit congestion notification (ECN) to signal congestion without dropping packets, allowing devices to adjust their transmission rates proactively; (d) wherein said ECN comprises detecting congestion at the MAC or physical (PHY) layer which is communicated by the MAC layer sending cross-link primitives to upper layers to communicate congestion information, data rate indications, marking packets to indicate that contention has been experienced, requests for L4S packet enqueuing, toward supporting L4S features in the MAC layer, which reduce latency of L4S packet transmissions.

An apparatus having a queuing architecture designed with different configurations depending on whether L4S queues are implemented at the MAC layer or above the MAC layer.

An apparatus having cross-link primitives defined between MAC, PHY and the upper layers to support L4S features in 802.11, which are separately designed based on different queuing architectures.

An apparatus having CE marking in 802.11 MAC and allowing CE marking above 802.11 MAC depending on different queuing architectures.

An apparatus having a TCLAS element configured to classify the PDU or MSDU from upper layer as L4S traffic.

An apparatus having an SCS Descriptor element configured to reflect the coexistence of SCS flows and L4S flows.

The apparatus or method or system of any preceding or following implementation, further comprising maintaining one or more higher levels packet queues in the upper layers, which buffer packets before they are directed into the MAC queues.

The apparatus or method of any preceding or following implementation, wherein said ECN is configured for performing flow control communication with an application executing in the upper layers, above the MAC layer, to limit transmissions from the application which would lead to congestion problems.

The apparatus or method of any preceding or following implementation, wherein said ECN comprises performing ECN marking in which subsequent packet headers are marked with an explicit congestion indication which is passed to the layers above the MAC layer.

The apparatus or method of any preceding or following implementation, wherein said marking of packets to indicate contention, as CE marking, is performed in the upper layers in response to receiving cross-link primitives marking directives from the MAC layer.

The apparatus or method of any preceding or following implementation, further comprising a traffic classification (TCLAS) element is designed to classify protocol data units (PDUs) or MAC service data unit (MSDUs) from an upper layer in L4S traffic.

The apparatus or method of any preceding or following implementation, further comprising a stream classification service (SCS) descriptor element to reflect coexistence between SCS flows and L4S flows.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1
ECN Codepoint Values

| ECN Codepoint | Binary | L4S Meaning |
|---|---|---|
| Not-ECT | 00 | Not ECN-capable transport |
| ECT(0) | 10 | Classic ECN-capable transport |
| ECT(1) | 01 | L4S-capable transport |
| CE | 11 | Congestion experienced |

What is claimed is:

1. An apparatus for communication in a wireless network, the apparatus comprising:
(a) a wireless station (STA) configured with a queuing architecture supporting low latency low loss scalable throughput (L4S) and dual queue active queue management (AQM) in which queues for both L4S streams and classic streams are contained in the medium access control (MAC) layer, with at least one of these queues configured with more than one internal queue, to which different L4S packets and other packet types are retained in different internal queues within the MAC transmit queues;
(b) wherein said STA operates as either an access point (AP) or non-AP STA;
(c) at least one processor of said STA and a non-transitory memory storing instructions executable by the at least one processor for wirelessly communicating from the STA with other STAs on an IEEE 802.11 wireless local area network (WLAN); and
(d) wherein said instructions, when executed by the at least one processor, perform steps of a wireless communications protocol, comprising:
(i) maintaining queues for both L4S streams and classic streams in the medium access control (MAC) layer, wherein each MAC queue is configured for buffering L4S packets and classical packets in separate queues and queues having internal queues for buffering different packet types;
(ii) performing explicit congestion notification (ECN) to signal congestion without dropping packets, allowing devices to adjust their transmission rates proactively; and
(iii) wherein said ECN comprises detecting congestion at the MAC or physical (PHY) layer which is communicated by the MAC layer sending cross-link primitives to upper layers to communicate congestion information, data rate indications, marking packets to indicate that contention has been experienced, requests for L4S packet enqueuing, toward supporting L4S features in the MAC layer, which reduce latency of L4S packet transmissions.

2. The apparatus of claim 1, further comprising maintaining one or more higher levels packet queues in the upper layers, which buffer packets before they are directed into the MAC queues.

3. The apparatus of claim 1, wherein said ECN is configured for performing flow control communication with an application executing in the upper layers, above the MAC layer, to limit transmissions from the application which would lead to congestion problems.

4. The apparatus of claim 1, wherein said ECN comprises performing ECN marking in which subsequent packet headers are marked with an explicit congestion indication which is passed to the layers above the MAC layer.

5. The apparatus of claim 1, wherein said marking of packets to indicate contention, as CE marking, is performed in the upper layers in response to receiving cross-link primitives marking directives from the MAC layer.

6. The apparatus of claim 1, further comprising a traffic classification (TCLAS) element is designed to classify protocol data units (PDUs) or MAC service data unit (MSDUs) from an upper layer in L4S traffic.

7. The apparatus of claim 1, further comprising a stream classification service (SCS) descriptor element to reflect coexistence between SCS flows and L4S flows.

8. An apparatus for communication in a wireless network, the apparatus comprising:
(a) a wireless station (STA) configured with a queuing architecture supporting low latency low loss scalable throughput (L4S) and dual queue active queue management (AQM) in which queues for both L4S streams and classic streams are contained in the medium access control (MAC) layer, and one of more of these queues are configured with more than one internal queue, to which different L4S packets and other packet types are retained in different internal queues within the MAC transmit queues;
(b) wherein said STA operates as either an access point (AP) or non-AP STA;
(c) at least one processor of said STA and a non-transitory memory storing instructions executable by the at least one processor for wirelessly communicating from the STA with other STAs on an IEEE 802.11 wireless local area network (WLAN); and
(d) wherein said instructions, when executed by the at least one processor, perform steps of a wireless communications protocol, comprising:
(i) maintaining queues for both L4S streams and classic streams in the medium access control (MAC) layer, wherein each MAC queue is configured for buffering L4S packets and classical packets in separate queues and queues having internal queues for buffering different packet types;
(ii) further comprising maintaining one or more higher levels packet queues in the upper layers, which buffer packets before they are directed into the MAC queues;
(iii) performing explicit congestion notification (ECN) to signal congestion without dropping packets, allowing devices to adjust their transmission rates proactively; and
(iv) wherein said ECN comprises detecting congestion at the MAC or physical (PHY) layer which is communicated by the MAC layer sending cross-link primitives to upper layers to communicate congestion information, data rate indications, marking packets to indicate that contention has been experienced, requests for L4S packet enqueuing, toward supporting L4S features in the MAC layer, which reduce latency of L4S packet transmissions.

9. The apparatus of claim 8, wherein said ECN is configured for performing flow control communication with an application executing in the upper layers, above the MAC layer, to limit transmissions from the application which would lead to congestion problems.

10. The apparatus of claim 8, wherein said ECN comprises performing ECN marking in which subsequent packet headers are marked with an explicit congestion indication which is passed to the layers above the MAC layer.

11. The apparatus of claim 8, wherein said marking of packets to indicate contention, as CE marking, is performed in the upper layers in response to receiving cross-link primitives marking directives from the MAC layer.

12. The apparatus of claim 8, further comprising a traffic classification (TCLAS) element is designed to classify protocol data units (PDUs) or MAC service data unit (MSDUs) from an upper layer in L4S traffic.

13. The apparatus of claim 8, further comprising a stream classification service (SCS) descriptor element to reflect coexistence between SCS flows and L4S flows.

14. A method for communicating in a wireless network, comprising:
(a) supporting low latency low loss scalable throughput (L4S) and dual queue active queue management (AQM) in a wireless station (STA) having a queuing architecture which has queues for both L4S streams and classic streams contained in the medium access control (MAC) layer, wherein at least one of these queues are configured with more than one internal queue, to which different L4S packets and other packet types are retained in different internal queues within the MAC transmit queues for communicating on an IEEE 802.11 wireless local area network (WLAN);
(b) maintaining the queues for both L4S streams and classic streams in the medium access control (MAC) layer, wherein each MAC queue is configured for buffering L4S packets and classical packets in separate queues and queues having internal queues for buffering different packet types;
(c) performing explicit congestion notification (ECN) to signal congestion without dropping packets, allowing devices to adjust their transmission rates proactively; and
(d) wherein said ECN comprises detecting congestion at the MAC or physical (PHY) layer which is communicated by the MAC layer sending cross-link primitives to upper layers to communicate congestion information, data rate indications, marking packets to indicate that contention has been experienced, requests for L4S packet enqueuing, toward supporting L4S features in the MAC layer, which reduce latency of L4S packet transmissions.

15. The method of claim 14, further comprising maintaining one or more higher levels packet queues in the upper layers, which buffer packets before they are directed into the MAC queues.

16. The method of claim 14, wherein said ECN is configured for performing flow control communication with an application executing in the upper layers, above the MAC layer, to limit transmissions from the application which would lead to congestion problems.

17. The method of claim 14, wherein said ECN comprises performing ECN marking in which subsequent packet headers are marked with an explicit congestion indication which is passed to the layers above the MAC layer.

18. The method of claim 14, wherein said marking of packets to indicate contention, as CE marking, is performed in the upper layers in response to receiving cross-link primitives marking directives from the MAC layer.

19. The method of claim 14, further comprising a traffic classification (TCLAS) element is designed to classify protocol data units (PDUs) or MAC service data unit (MSDUs) from an upper layer in L4S traffic.

20. The method of claim 14, further comprising a stream classification service (SCS) descriptor element to reflect coexistence between SCS flows and L4S flows.
